(19) United States
(12) Patent Application Publication
(10) Pub. No.: US 2025/0123358 A1
(43) Pub. Date: Apr. 17, 2025

(54) APPARATUS, SYSTEM, AND METHOD OF FUNCTIONAL SAFETY DETECTOR FOR RADAR PROCESSING PATH

(71) Applicant: MobilEye Vision Technologies Ltd., Jerusalem (IL)

(72) Inventors: Oren Shalita, Tel-Aviv (IL); Nati Dinur, Atlit (IL); Moshe Teplitsky, Tel-Aviv (IL); Adi Panzer, Tel-Aviv (IL)

(73) Assignee: MobilEye Vision Technologies Ltd., Jerusalem (IL)

(21) Appl. No.: 18/915,182

(22) Filed: Oct. 14, 2024

Related U.S. Application Data
(60) Provisional application No. 63/590,557, filed on Oct. 16, 2023.

(51) Int. Cl. G01S 7/40; G01S 7/35; G01S 13/58; G01S 13/89; G01S 13/93

(52) U.S. Cl. CPC G01S 7/40; G01S 7/356; G01S 13/583; G01S 13/89; G01S 13/93

(57) ABSTRACT

For example, a Functional Safety (FuSa) detector may be configured to detect FuSa events of an imaging radar processing path including a plurality of radar processing stages to generate radar information based on transmission of radar transmit (Rx) signals and processing of radar receive (Rx) signals based on the radar Rx signals. For example, the FuSa detector may include an input to receive a digital output of a radar processing stage of the imaging radar processing path; a processor configured to monitor the digital output, and to detect a FuSa event based on current data in the digital output and reference information corresponding to the radar processing stage; and an output to provide a FuSa alert to indicate detection of the FuSa event.

### CROSS REFERENCE

This Application claims the benefit of and priority from U.S. Provisional Patent Application No. 63/590,557 entitled “APPARATUS, SYSTEM, AND METHOD OF FUNCTIONAL SAFETY DETECTOR FOR RADAR PROCESSING PATH”, filed Oct. 16, 2023, the entire disclosure of which is incorporated herein by reference.

### BACKGROUND

Various types of devices and systems, for example, autonomous and/or robotic devices, e.g., autonomous vehicles and robots, may be configured to perceive and navigate through their environment using sensor data of one or more sensor types.

Conventionally, autonomous perception relies heavily on light-based sensors, such as image sensors, e.g., cameras, and/or Light Detection and Ranging (LiDAR) sensors. Such light-based sensors may perform poorly under certain conditions, such as, conditions of poor visibility, or in certain inclement weather conditions, e.g., rain, snow, hail, or other forms of precipitation, thereby limiting their usefulness or reliability.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation.

Furthermore, reference numerals may be repeated among the figures to indicate corresponding or analogous elements. The figures are listed below.

FIG. 1 is a schematic block diagram illustration of a vehicle implementing a radar, in accordance with some demonstrative aspects.

FIG. 2 is a schematic block diagram illustration of a robot implementing a radar, in accordance with some demonstrative aspects.

FIG. 3 is a schematic block diagram illustration of a radar apparatus, in accordance with some demonstrative aspects.

FIG. 4 is a schematic block diagram illustration of a Frequency-Modulated Continuous Wave (FMCW) radar apparatus, in accordance with some demonstrative aspects.

FIG. 5 is a schematic illustration of an extraction scheme, which may be implemented to extract range and speed (Doppler) estimations from digital reception radar data values, in accordance with some demonstrative aspects.

FIG. 6 is a schematic illustration of an angle-determination scheme, which may be implemented to determine Angle of Arrival (AoA) information based on an incoming radio signal received by a receive antenna array, in accordance with some demonstrative aspects.

FIG. 7 is a schematic illustration of a Multiple-Input-Multiple-Output (MIMO) radar antenna scheme, which may be implemented based on a combination of Transmit (Tx) and Receive (Rx) antennas, in accordance with some demonstrative aspects.

FIG. 8 is a schematic block diagram illustration of elements of a radar device including a radar frontend and a radar processor, in accordance with some demonstrative aspects.

FIG. 9 is a schematic illustration of a radar system including a plurality of radar devices implemented in a vehicle, in accordance with some demonstrative aspects.

FIG. 10 is a schematic illustration of a radar system including a Functional Safety (FuSa) detector, in accordance with some demonstrative aspects.

FIG. 11 is a schematic illustration of a radar system including a FuSa detector, in accordance with some demonstrative aspects.

FIG. 12 is a schematic illustration of a Range Doppler (RD) map of a frame, which may be implemented in accordance with some demonstrative aspects.

FIG. 13 is a schematic illustration of a matched filter output, which may be implemented in accordance with some demonstrative aspects.

FIG. 14 is a schematic illustration of a first Angle of Arrival (AoA) map and a second AoA map of an RD bin, which may be implemented in accordance with some demonstrative aspects.

FIG. 15 is a schematic illustration of elements of a radar processing path, which may be implemented for FuSa event detection, in accordance with some demonstrative aspects.

FIG. 16 is a schematic illustration of elements of a radar processing path, which may be implemented for FuSa detection, in accordance with some demonstrative aspects.

FIG. 17 is a schematic illustration of elements of a Tx processing path, which may be implemented for FuSa event detection, in accordance with some demonstrative aspects.

FIG. 18 is a schematic illustration of elements of an Rx processing path, which may be implemented for FuSa event detection, in accordance with some demonstrative aspects.

FIG. 19 is a schematic flow chart illustration of a method of detecting FuSa events, in accordance with some demonstrative aspects.

FIG. 20 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, aspect, or design described herein as “exemplary” or “demonstrative” is not necessarily to be construed as preferred or advantageous over other aspects, aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and/or may represent any information as understood in the art.

The terms “processor” or “controller” may be understood to include any kind of technological entity that allows handling of any suitable type of data and/or information. The data and/or information may be handled according to one or more specific functions executed by the processor or controller. Further, a processor or a controller may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), and the like, or any combination thereof. Any other kind of implementation of the respective functions, which will be described below in further detail, may also be understood as a processor, controller, or logic circuit. It is understood that any two (or more) processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “memory” is understood as a computer-readable medium (e.g., a non-transitory computer-readable medium) in which data or information can be stored for retrieval. References to “memory” may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” may be used to refer to any type of executable instruction and/or logic, including firmware.

A “vehicle” may be understood to include any type of driven object. By way of example, a vehicle may be a driven object with a combustion engine, an electric engine, a reaction engine, an electrically driven object, a hybrid driven object, or a combination thereof. A vehicle may be, or may include, an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, a rocket, among others.

A “ground vehicle” may be understood to include any type of vehicle, which is configured to traverse the ground, e.g., on a street, on a road, on a track, on one or more rails, off-road, or the like.

An “autonomous vehicle” may describe a vehicle capable of implementing at least one navigational change without driver input. A navigational change may describe or include a change in one or more of steering, braking, acceleration/deceleration, or any other operation relating to movement, of the vehicle. A vehicle may be described as autonomous even in case the vehicle is not fully autonomous, for example, fully operational with driver or without driver input. Autonomous vehicles may include those vehicles that can operate under driver control during certain time periods, and without driver control during other time periods. Additionally or alternatively, autonomous vehicles may include vehicles that control only some aspects of vehicle navigation, such as steering, e.g., to maintain a vehicle course between vehicle lane constraints, or some steering operations under certain circumstances, e.g., not under all circumstances, but may leave other aspects of vehicle navigation to the driver, e.g., braking or braking under certain circumstances. Additionally or alternatively, autonomous vehicles may include vehicles that share the control of one or more aspects of vehicle navigation under certain circumstances, e.g., hands-on, such as responsive to a driver input; and/or vehicles that control one or more aspects of vehicle navigation under certain circumstances, e.g., hands-off, such as independent of driver input. Additionally or alternatively, autonomous vehicles may include vehicles that control one or more aspects of vehicle navigation under certain circumstances, such as under certain environmental conditions, e.g., spatial areas, roadway conditions, or the like. In some aspects, autonomous vehicles may handle some or all aspects of braking, speed control, velocity control, steering, and/or any other additional operations, of the vehicle. An autonomous vehicle may include those vehicles that can operate without a driver. The level of autonomy of a vehicle may be described or determined by the Society of Automotive Engineers (SAE) level of the vehicle, e.g., as defined by the SAE, for example, in SAE J3016 2018: Taxonomy and definitions for terms related to driving automation systems for on road motor vehicles, or by other relevant professional organizations. The SAE level may have a value ranging from a minimum level, e.g., level 0 (illustratively, substantially no driving automation), to a maximum level, e.g., level 5 (illustratively, full driving automation).

An “assisted vehicle” may describe a vehicle capable of informing a driver or occupant of the vehicle of sensed data or information derived therefrom.

The phrase “vehicle operation data” may be understood to describe any type of feature related to the operation of a vehicle. By way of example, “vehicle operation data” may describe the status of the vehicle, such as, the type of tires of the vehicle, the type of vehicle, and/or the age of the manufacturing of the vehicle. More generally, “vehicle operation data” may describe or include static features or static vehicle operation data (illustratively, features or data not changing over time). As another example, additionally or alternatively, “vehicle operation data” may describe or include features changing during the operation of the vehicle, for example, environmental conditions, such as weather conditions or road conditions during the operation of the vehicle, fuel levels, fluid levels, operational parameters of the driving source of the vehicle, or the like. More generally, “vehicle operation data” may describe or include varying features or varying vehicle operation data (illustratively, time varying features or data).

Some aspects may be used in conjunction with various devices and systems, for example, a radar sensor, a radar device, a radar system, a vehicle, a vehicular system, an autonomous vehicular system, a vehicular communication system, a vehicular device, an airborne platform, a waterborne platform, road infrastructure, sports-capture infrastructure, city monitoring infrastructure, static infrastructure platforms, indoor platforms, moving platforms, robot platforms, industrial platforms, a sensor device, a User Equipment (UE), a Mobile Device (MD), a wireless station (STA), a sensor device, a non-vehicular device, a mobile or portable device, and the like.

Some aspects may be used in conjunction with Radio Frequency (RF) systems, radar systems, vehicular radar systems, autonomous systems, robotic systems, detection systems, or the like.

Some demonstrative aspects may be used in conjunction with an RF frequency in a frequency band having a starting frequency above 10 Gigahertz (GHz), for example, a frequency band having a starting frequency between 10 GHz and 120 GHz. For example, some demonstrative aspects may be used in conjunction with an RF frequency having a starting frequency above 30 GHz, for example, above 45 GHz, e.g., above 60 GHz. For example, some demonstrative aspects may be used in conjunction with an automotive radar frequency band, e.g., a frequency band between 76 GHz and 81 GHz. However, other aspects may be implemented utilizing any other suitable frequency bands, for example, a frequency band above 140 GHz, a frequency band of 300 GHz, a sub Terahertz (THz) band, a THz band, an Infra-Red (IR) band, and/or any other frequency band.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, some functions associated with the circuitry may be implemented by one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

The term “communicating” as used herein with respect to a signal includes transmitting the signal and/or receiving the signal. For example, an apparatus, which is capable of communicating a signal, may include a transmitter to transmit the signal, and/or a receiver to receive the signal. The verb communicating may be used to refer to the action of transmitting or the action of receiving. In one example, the phrase “communicating a signal” may refer to the action of transmitting the signal by a transmitter, and may not necessarily include the action of receiving the signal by a receiver. In another example, the phrase “communicating a signal” may refer to the action of receiving the signal by a receiver, and may not necessarily include the action of transmitting the signal by a transmitter.

The term “antenna”, as used herein, may include any suitable configuration, structure, and/or arrangement of one or more antenna elements, components, units, assemblies, and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a MIMO (Multiple-Input Multiple-Output) array antenna, a single element antenna, a set of switched beam antennas, and/or the like. In one example, an antenna may be implemented as a separate element or an integrated element, for example, as an on-module antenna, an on-chip antenna, or according to any other antenna architecture.

Some demonstrative aspects are described herein with respect to RF radar signals. However, other aspects may be implemented with respect to, or in conjunction with, any other radar signals, wireless signals, IR signals, acoustic signals, optical signals, wireless communication signals, communication scheme, network, standard, and/or protocol. For example, some demonstrative aspects may be implemented with respect to systems, e.g., Light Detection Ranging (LiDAR) systems, and/or sonar systems, utilizing light and/or acoustic signals.

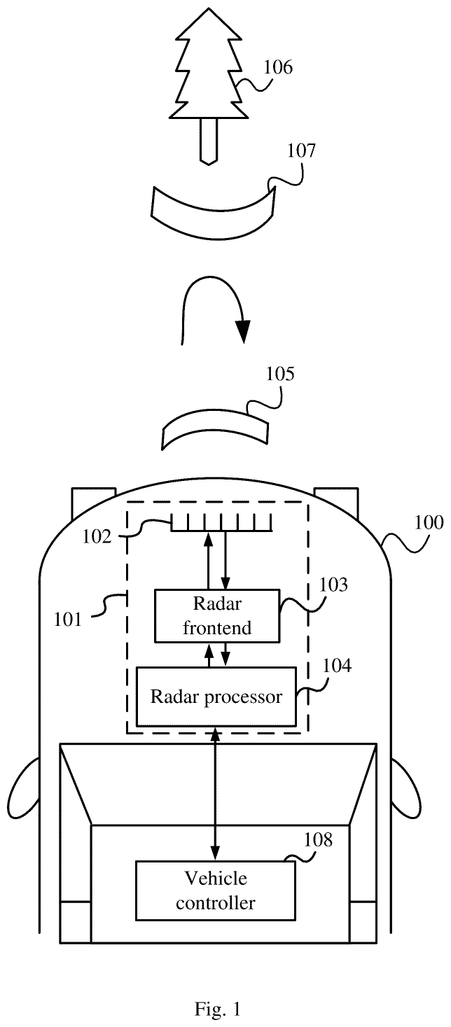

Reference is now made to FIG. 1, which schematically illustrates a block diagram of a vehicle 100 implementing a radar, in accordance with some demonstrative aspects.

In some demonstrative aspects, vehicle 100 may include a car, a truck, a motorcycle, a bus, a train, an airborne vehicle, a waterborne vehicle, a cart, a golf cart, an electric cart, a road agent, or any other vehicle.

In some demonstrative aspects, vehicle 100 may include a radar device 101, e.g., as described below. For example, radar device 101 may include a radar detecting device, a radar sensing device, a radar sensor, or the like, e.g., as described below.

In some demonstrative aspects, radar device 101 may be implemented as part of a vehicular system, for example, a system to be implemented and/or mounted in vehicle 100.

In one example, radar device 101 may be implemented as part of an autonomous vehicle system, an automated driving system, an assisted vehicle system, a driver assistance and/or support system, and/or the like.

For example, radar device 101 may be installed in vehicle 100 for detection of nearby objects, e.g., for autonomous driving.

In some demonstrative aspects, radar device 101 may be configured to detect targets in a vicinity of vehicle 100, e.g., in a far vicinity and/or a near vicinity, for example, using RF and analog chains, capacitor structures, large spiral transformers and/or any other electronic or electrical elements, e.g., as described below.

In one example, radar device 101 may be mounted onto, placed, e.g., directly, onto, or attached to, vehicle 100.

In some demonstrative aspects, vehicle 100 may include a plurality of radar aspects, vehicle 100 may include a single radar device 101.

In some demonstrative aspects, vehicle 100 may include a plurality of radar devices 101, which may be configured to cover a field of view of 360 degrees around vehicle 100.

In other aspects, vehicle 100 may include any other suitable count, arrangement, and/or configuration of radar devices and/or units, which may be suitable to cover any other field of view, e.g., a field of view of less than 360 degrees.

In some demonstrative aspects, radar device 101 may be implemented as a component in a suite of sensors used for driver assistance and/or autonomous vehicles, for example, due to the ability of radar to operate in nearly all-weather conditions.

In some demonstrative aspects, radar device 101 may be configured to support autonomous vehicle usage, e.g., as described below.

In one example, radar device 101 may determine a class, a location, an orientation, a velocity, an intention, a perceptional understanding of the environment, and/or any other information corresponding to an object in the environment.

In another example, radar device 101 may be configured to determine one or more parameters and/or information for one or more operations and/or tasks, e.g., path planning, and/or any other tasks.

In some demonstrative aspects, radar device 101 may be configured to map a scene by measuring targets' echoes (reflectivity) and discriminating them, for example, mainly in range, velocity, azimuth and/or elevation, e.g., as described below.

In some demonstrative aspects, radar device 101 may be configured to detect, and/or sense, one or more objects, which are located in a vicinity, e.g., a far vicinity and/or a near vicinity, of the vehicle 100, and to provide one or more parameters, attributes, and/or information with respect to the objects.

In some demonstrative aspects, the objects may include road users, such as other vehicles, pedestrians; road objects and markings, such as traffic signs, traffic lights, lane markings, road markings, road elements, e.g., a pavement-road meeting, a road edge, a road profile, road roughness (or smoothness); general objects, such as a hazard, e.g., a tire, a box, a crack in the road surface; and/or the like.

In some demonstrative aspects, the one or more parameters, attributes and/or information with respect to the object may include a range of the objects from the vehicle 100, an angle of the object with respect to the vehicle 100, a location of the object with respect to the vehicle 100, a relative speed of the object with respect to vehicle 100, and/or the like.

In some demonstrative aspects, radar device 101 may include a Multiple Input Multiple Output (MIMO) radar device 101, e.g., as described below.

In one example, the MIMO radar device may be configured to utilize “spatial filtering” processing, for example, beamforming and/or any other mechanism, for one or both of Transmit (Tx) signals and/or Receive (Rx) signals.

Some demonstrative aspects are described below with respect to a radar device, e.g., radar device 101, implemented as a MIMO radar. However, in other aspects, radar device 101 may be implemented as any other type of radar utilizing a plurality of antenna elements, e.g., a Single Input Multiple Output (SIMO) radar or a Multiple Input Single output (MISO) radar.

Some demonstrative aspects may be implemented with respect to a radar device, e.g., radar device 101, implemented as a MIMO radar, e.g., as described below. However, in other aspects, radar device 101 may be implemented as any other type of radar, for example, an Electronic Beam Steering radar, a Synthetic Aperture Radar (SAR), adaptive and/or cognitive radars that change their transmission according to the environment and/or ego state, a reflect array radar, or the like.

In some demonstrative aspects, radar device 101 may include an antenna arrangement 102, a radar frontend 103 configured to communicate radar signals via the antenna arrangement 102, and a radar processor 104 configured to generate radar information based on the radar signals, e.g., as described below.

In some demonstrative aspects, radar processor 104 may be configured to process radar information of radar device 101 and/or to control one or more operations of radar device 101, e.g., as described below.

In some demonstrative aspects, radar processor 104 may include, or may be implemented, partially or entirely, by circuitry and/or logic, e.g., one or more processors including circuitry and/or logic, memory circuitry and/or logic. Additionally or alternatively, one or more functionalities of radar processor 104 may be implemented by logic, which may be executed by a machine and/or one or more processors, e.g., as described below.

In one example, radar processor 104 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In other aspects, radar processor 104 may be implemented by one or more additional or alternative elements of vehicle 100.

In some demonstrative aspects, radar frontend 103 may include, for example, one or more (radar) transmitters, and a one or more (radar) receivers, e.g., as described below.

In some demonstrative aspects, antenna arrangement 102 may include a plurality of antennas to communicate the radar signals. For example, antenna arrangement 102 may include multiple transmit antennas in the form of a transmit antenna array, and multiple receive antennas in the form of a receive antenna array. In another example, antenna arrangement 102 may include one or more antennas used both as transmit and receive antennas. In the latter case, the radar frontend 103, for example, may include a duplexer or a circulator, e.g., a circuit to separate transmitted signals from received signals.

In some demonstrative aspects, as shown in FIG. 1, the radar frontend 103 and the antenna arrangement 102 may be controlled, e.g., by radar processor 104, to transmit a radio transmit signal 105.

In some demonstrative aspects, as shown in FIG. 1, the radio transmit signal 105 may be reflected by an object 106, resulting in an echo 107.

In some demonstrative aspects, the radar device 101 may receive the echo 107, e.g., via antenna arrangement 102 and radar frontend 103, and radar processor 104 may generate radar information, for example, by calculating information about position, radial velocity (Doppler), and/or direction of the object 106, e.g., with respect to vehicle 100.

In some demonstrative aspects, radar processor 104 may be configured to provide the radar information to a vehicle controller 108 of the vehicle 100, e.g., for autonomous driving of the vehicle 100.

In some demonstrative aspects, at least part of the functionality of radar processor 104 may be implemented as part of vehicle controller 108. In other aspects, the functionality of radar processor 104 may be implemented as part of any other element of radar device 101 and/or vehicle 100. In other aspects, radar processor 104 may be implemented, as a separate part of, or as part of any other element of radar device 101 and/or vehicle 100.

In some demonstrative aspects, vehicle controller 108 may be configured to control one or more functionalities, modes of operation, components, devices, systems, and/or elements of vehicle 100.

In some demonstrative aspects, vehicle controller 108 may be configured to control one or more vehicular systems of vehicle 100, e.g., as described below.

In some demonstrative aspects, the vehicular systems may include, for example, a steering system, a braking system, a driving system, and/or any other system of the vehicle 100.

In some demonstrative aspects, vehicle controller 108 may configured to control radar device 101, and/or to process one or parameters, attributes and/or information from radar device 101.

In some demonstrative aspects, vehicle controller 108 may be configured, for example, to control the vehicular systems of the vehicle 100, for example, based on radar information from radar device 101 and/or one or more other sensors of the vehicle 100, e.g., Light Detection and Ranging (LIDAR) sensors, camera sensors, and/or the like.

In one example, vehicle controller 108 may control the steering system, the braking system, and/or any other vehicular systems of vehicle 100, for example, based on the information from radar device 101, e.g., based on one or more objects detected by radar device 101.

In other aspects, vehicle controller 108 may be configured to control any other additional or alternative functionalities of vehicle 100.

Some demonstrative aspects are described herein with respect to a radar device 101 implemented in a vehicle, e.g., vehicle 100. In other aspects a radar device, e.g., radar device 101, may be implemented as part of any other element of a traffic system or network, for example, as part of a road infrastructure, and/or any other element of a traffic network or system. Other aspects may be implemented with respect to any other system, environment, and/or apparatus, which may be implemented in any other object, environment, location, or place. For example, radar device 101 may be part of a non-vehicular device, which may be implemented, for example, in an indoor location, a stationary infrastructure outdoors, or any other location.

In some demonstrative aspects, radar device 101 may be configured to support security usage. In one example, radar device 101 may be configured to determine a nature of an operation, e.g., a human entry, an animal entry, an environmental movement, and the like, to identity a threat level of a detected event, and/or any other additional or alternative operations.

Some demonstrative aspects may be implemented with respect to any other additional or alternative devices and/or systems, for example, for a robot, e.g., as described below.

In other aspects, radar device 101 may be configured to support any other usages and/or applications.

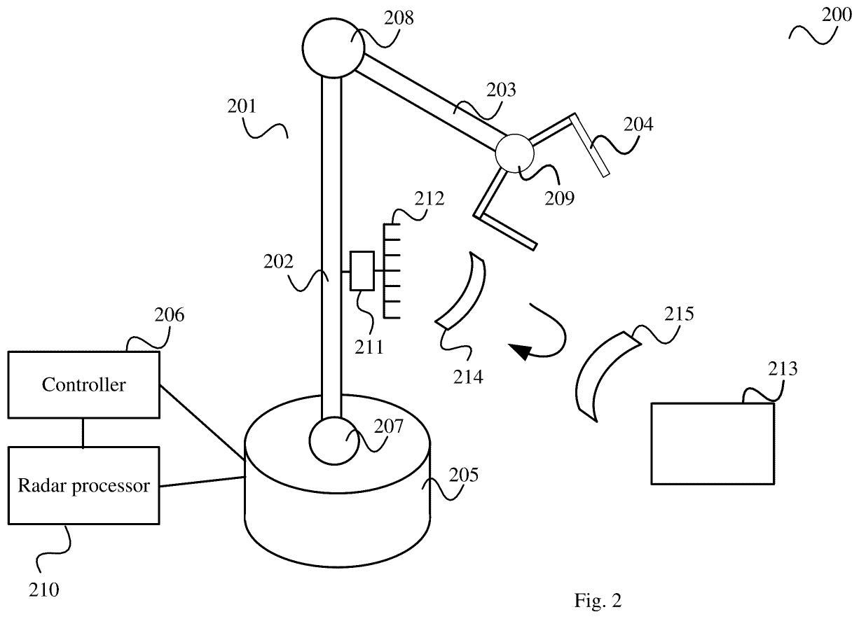

Reference is now made to FIG. 2, which schematically illustrates a block diagram of a robot 200 implementing a radar, in accordance with some demonstrative aspects.

In some demonstrative aspects, robot 200 may include a robot arm 201. The robot 200 may be implemented, for example, in a factory for handling an object 213, which may be, for example, a part that should be affixed to a product that is being manufactured. The robot arm 201 may include a plurality of movable members, for example, movable members 202, 203, 204, and a support 205. Moving the movable members 202, 203, and/or 204 of the robot arm 201, e.g., by actuation of associated motors, may allow physical interaction with the environment to carry out a task, e.g., handling the object 213.

In some demonstrative aspects, the robot arm 201 may include a plurality of joint elements, e.g., joint elements 207, 208, 209, which may connect, for example, the members 202, 203, and/or 204 with each other, and with the support 205. For example, a joint element 207, 208, 209 may have one or more joints, each of which may provide rotatable motion, e.g., rotational motion, and/or translatory motion, e.g., displacement, to associated members and/or motion of members relative to each other. The movement of the members 202, 203, 204 may be initiated by suitable actuators.

In some demonstrative aspects, the member furthest from the support 205, e.g., member 204, may also be referred to as the end-effector 204 and may include one or more tools, such as, a claw for gripping an object, a welding tool, or the like. Other members, e.g., members 202, 203, closer to the support 205, may be utilized to change the position of the end-effector 204, e.g., in three-dimensional space. For example, the robot arm 201 may be configured to function similarly to a human arm, e.g., possibly with a tool at its end.

In some demonstrative aspects, robot 200 may include a (robot) controller 206 configured to implement interaction with the environment, e.g., by controlling the robot arm's actuators, according to a control program, for example, in order to control the robot arm 201 according to the task to be performed.

In some demonstrative aspects, an actuator may include a component adapted to affect a mechanism or process in response to being driven. The actuator can respond to commands given by the controller 206 (the so-called activation) by performing mechanical movement. This means that an actuator, typically a motor (or electromechanical converter), may be configured to convert electrical energy into mechanical energy when it is activated (i.e. actuated).

In some demonstrative aspects, controller 206 may be in communication with a radar processor 210 of the robot 200.

In some demonstrative aspects, a radar fronted 211 and a radar antenna arrangement 212 may be coupled to the radar processor 210. In one example, radar fronted 211 and/or radar antenna arrangement 212 may be included, for example, as part of the robot arm 201.

In some demonstrative aspects, the radar frontend 211, the radar antenna arrangement 212 and the radar processor 210 may be operable as, and/or may be configured to form, a radar device. For example, antenna arrangement 212 may be configured to perform one or more functionalities of antenna arrangement 102 (FIG. 1), radar frontend 211 may be configured to perform one or more functionalities of radar frontend 103 (FIG. 1), and/or radar processor 210 may be configured to perform one or more functionalities of radar processor 104 (FIG. 1), e.g., as described above.

In some demonstrative aspects, for example, the radar frontend 211 and the antenna arrangement 212 may be controlled, e.g., by radar processor 210, to transmit a radio transmit signal 214.

In some demonstrative aspects, as shown in FIG. 2, the radio transmit signal 214 may be reflected by the object 213, resulting in an echo 215.

In some demonstrative aspects, the echo 215 may be received, e.g., via antenna arrangement 212 and radar frontend 211, and radar processor 210 may generate radar information, for example, by calculating information about position, speed (Doppler) and/or direction of the object 213, e.g., with respect to robot arm 201.

In some demonstrative aspects, radar processor 210 may be configured to provide the radar information to the robot controller 206 of the robot arm 201, e.g., to control robot arm 201. For example, robot controller 206 may be configured to control robot arm 201 based on the radar information, e.g., to grab the object 213 and/or to perform any other operation.

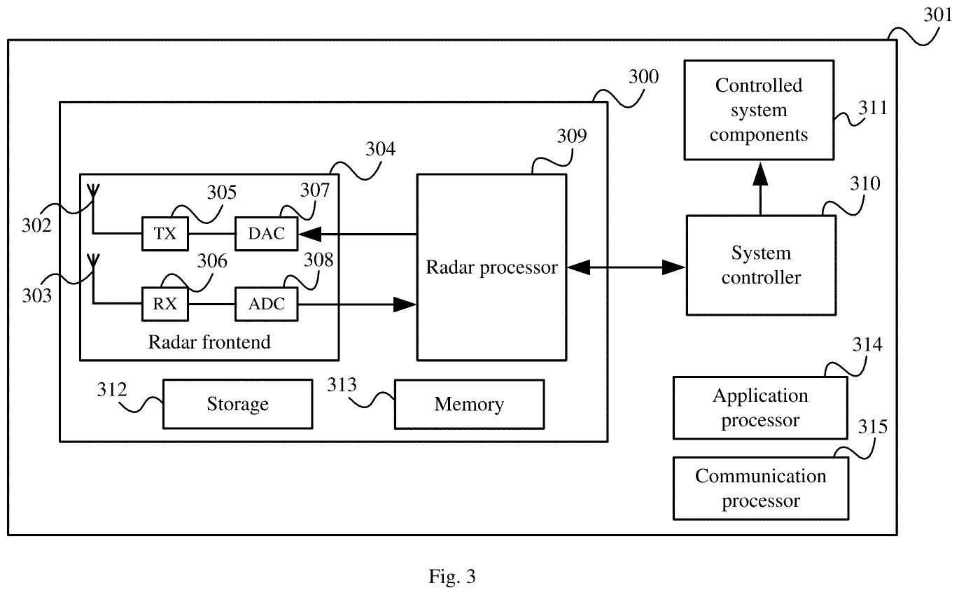

Reference is made to FIG. 3, which schematically illustrates a radar apparatus 300, in accordance with some demonstrative aspects.

In some demonstrative aspects, radar apparatus 300 may be implemented as part of a device or system 301, e.g., as described below.

For example, radar apparatus 300 may be implemented as part of, and/or may configured to perform one or more operations and/or functionalities of, the devices or systems described above with reference to FIG. 1 an/or FIG. 2. In other aspects, radar apparatus 300 may be implemented as part of any other device or system 301.

In some demonstrative aspects, radar device 300 may include an antenna arrangement, which may include one or more transmit antennas 302 and one or more receive antennas 303. In other aspects, any other antenna arrangement may be implemented.

In some demonstrative aspects, radar device 300 may include a radar frontend 304, and a radar processor 309.

In some demonstrative aspects, as shown in FIG. 3, the one or more transmit antennas 302 may be coupled with a transmitter (or transmitter arrangement) 305 of the radar frontend 304; and/or the one or more receive antennas 303 may be coupled with a receiver (or receiver arrangement) 306 of the radar frontend 304, e.g., as described below.

In some demonstrative aspects, transmitter 305 may include one or more elements, for example, an oscillator, a power amplifier and/or one or more other elements, configured to generate radio transmit signals to be transmitted by the one or more transmit antennas 302, e.g., as described below.

In some demonstrative aspects, for example, radar processor 309 may provide digital radar transmit data values to the radar frontend 304. For example, radar frontend 304 may include a Digital-to-Analog Converter (DAC) 307 to convert the digital radar transmit data values to an analog transmit signal. The transmitter 305 may convert the analog transmit signal to a radio transmit signal which is to be transmitted by transmit antennas 302.

In some demonstrative aspects, receiver 306 may include one or more elements, for example, one or more mixers, one or more filters and/or one or more other elements, configured to process, down-convert, radio signals received via the one or more receive antennas 303, e.g., as described below.

In some demonstrative aspects, for example, receiver 306 may convert a radio receive signal received via the one or more receive antennas 303 into an analog receive signal. The radar frontend 304 may include an Analog-to-Digital Converter (ADC) 308 to generate digital radar reception data values based on the analog receive signal. For example, radar frontend 304 may provide the digital radar reception data values to the radar processor 309.

In some demonstrative aspects, radar processor 309 may be configured to process the digital radar reception data values, for example, to detect one or more objects, e.g., in an environment of the device/system 301. This detection may include, for example, the determination of information including one or more of range, speed (Doppler), direction, and/or any other information, of one or more objects, e.g., with respect to the system 301.

In some demonstrative aspects, radar processor 309 may be configured to provide the determined radar information to a system controller 310 of device/system 301. For example, system controller 310 may include a vehicle controller, e.g., if device/system 301 includes a vehicular device/system, a robot controller, e.g., if device/system 301 includes a robot device/system, or any other type of controller for any other type of device/system 301.

In some demonstrative aspects, the radar information from radar processor 309 may be processed, e.g., by system controller 310 and/or any other element of system 301, for example, in combination with information from one or more other of information sources, for example, LiDAR information from a LiDAR processor, vision information from a vision-based processor, or the like.

In some demonstrative aspects, an environmental model of an environment of system 301 may be determined, e.g., by system controller 310 and/or any other element of system 301, for example, based on the radar information from radar processor 309, and/or the information from one or more other of information sources.

In some demonstrative aspects, a driving policy system, e.g., which may be implemented by system controller 310 and/or any other element of system 301, may process the environmental model, for example, to decide on one or more actions, which may be taken.

In some demonstrative aspects, system controller 310 may be configured to control one or more controlled system components 311 of the system 301, e.g. a motor, a brake, steering, and the like, e.g. by one or more corresponding actuators, for example, based on the one or more action decisions.

In some demonstrative aspects, radar device 300 may include a storage 312 or a memory 313, e.g., to store information processed by radar 300, for example, digital radar reception data values being processed by the radar processor 309, radar information generated by radar processor 309, and/or any other data to be processed by radar processor 309.

In some demonstrative aspects, device/system 301 may include, for example, an application processor 314 and/or a communication processor 315, for example, to at least partially implement one or more functionalities of system controller 310 and/or to perform communication between system controller 310, radar device 300, the controlled system components 311, and/or one or more additional elements of device/system 301.

In some demonstrative aspects, radar device 300 may be configured to generate and transmit the radio transmit signal in a form, which may support determination of range, speed, and/or direction, e.g., as described below.

For example, a radio transmit signal of a radar may be configured to include a plurality of pulses. For example, a pulse transmission may include the transmission of short high-power bursts in combination with times during which the radar device listens for echoes.

For example, in order to more optimally support a highly dynamic situation, e.g., in an automotive scenario, a Continuous Wave (CW) may instead be used as the radio transmit signal. However, a continuous wave, e.g., with constant frequency, may support velocity determination, but may not allow range determination, e.g., due to the lack of a time mark that could allow distance calculation.

In some demonstrative aspects, radio transmit signal 105 (FIG. 1) may be transmitted according to technologies such as, for example, Frequency-Modulated Continuous Wave (FMCW) radar, Phase-Modulated Continuous Wave (PMCW) radar, Orthogonal Frequency Division Multiplexing (OFDM) radar, and/or any other type of radar technology, which may support determination of range, velocity, and/or direction, e.g., as described below.

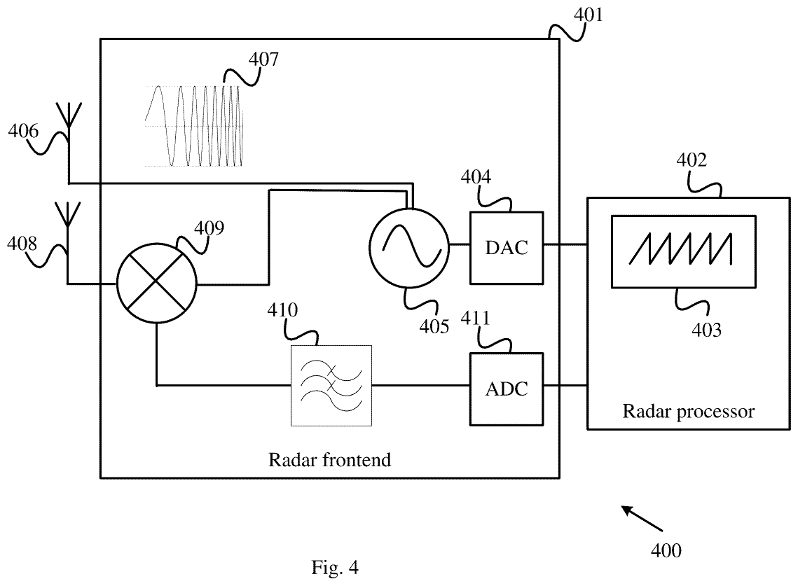

Reference is made to FIG. 4, which schematically illustrates a FMCW radar apparatus, in accordance with some demonstrative aspects.

In some demonstrative aspects, FMCW radar device 400 may include a radar frontend 401, and a radar processor 402. For example, radar frontend 304 (FIG. 3) may include one or more elements of, and/or may perform one or more operations and/or functionalities of, radar frontend 401; and/or radar processor 309 (FIG. 3) may include one or more elements of, and/or may perform one or more operations and/or functionalities of, radar processor 402.

In some demonstrative aspects, FMCW radar device 400 may be configured to communicate radio signals according to an FMCW radar technology, e.g., rather than sending a radio transmit signal with a constant frequency.

In some demonstrative aspects, radio frontend 401 may be configured to ramp up and reset the frequency of the transmit signal, e.g., periodically, for example, according to a saw tooth waveform 403. In other aspects, a triangle waveform, or any other suitable waveform may be used.

In some demonstrative aspects, for example, radar processor 402 may be configured to provide waveform 403 to frontend 401, for example, in digital form, e.g., as a sequence of digital values.

In some demonstrative aspects, radar frontend 401 may include a DAC 404 to convert waveform 403 into analog form, and to supply it to a voltage-controlled oscillator 405. For example, oscillator 405 may be configured to generate an output signal, which may be frequency-modulated in accordance with the waveform 403.

In some demonstrative aspects, oscillator 405 may be configured to generate the output signal including a radio transmit signal, which may be fed to and sent out by one or more transmit antennas 406.

In some demonstrative aspects, the radio transmit signal generated by the oscillator 405 may have the form of a sequence of chirps 407, which may be the result of the modulation of a sinusoid with the saw tooth waveform 403.

In one example, a chirp 407 may correspond to the sinusoid of the oscillator signal frequency-modulated by a “tooth” of the saw tooth waveform 403, e.g., from the minimum frequency to the maximum frequency.

In some demonstrative aspects, FMCW radar device 400 may include one or more receive antennas 408 to receive a radio receive signal. The radio receive signal may be based on the echo of the radio transmit signal, e.g., in addition to any noise, interference, or the like.

In some demonstrative aspects, radar frontend 401 may include a mixer 409 to mix the radio transmit signal with the radio receive signal into a mixed signal.

In some demonstrative aspects, radar frontend 401 may include a filter, e.g., a Low Pass Filter (LPF) 410, which may be configured to filter the mixed signal from the mixer 409 to provide a filtered signal. For example, radar frontend 401 may include an ADC 411 to convert the filtered signal into digital reception data values, which may be provided to radar processor 402. In another example, the filter 410 may be a digital filter, and the ADC 411 may be arranged between the mixer 409 and the filter 410.

In some demonstrative aspects, radar processor 402 may be configured to process the digital reception data values to provide radar information, for example, including range, speed (velocity/Doppler), and/or direction (AoA) information of one or more objects.

In some demonstrative aspects, radar processor 402 may be configured to perform a first Fast Fourier Transform (FFT) (also referred to as “range FFT”) to extract a delay response, which may be used to extract range information, and/or a second FFT (also referred to as “Doppler FFT”) to extract a Doppler shift response, which may be used to extract velocity information, from the digital reception data values.

In other aspects, any other additional or alternative methods may be utilized to extract range information. In one example, in a digital radar implementation, a correlation with the transmitted signal may be used, e.g., according to a matched filter implementation.

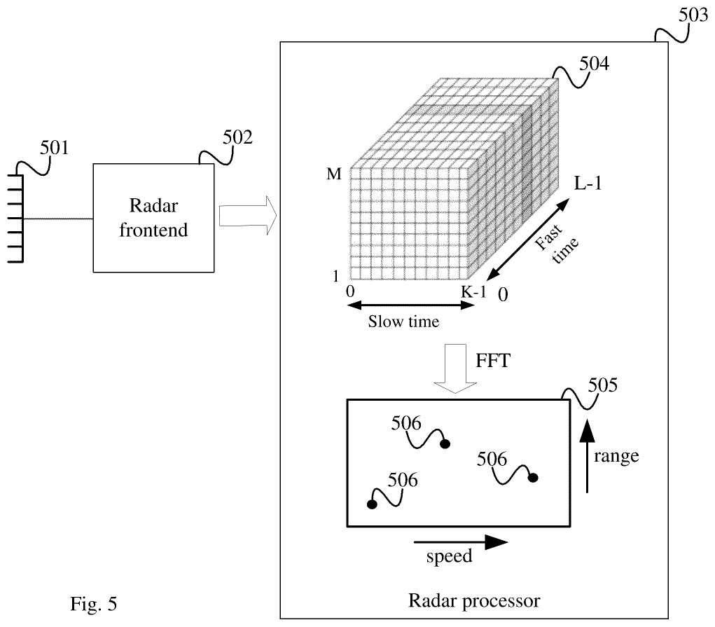

Reference is made to FIG. 5, which schematically illustrates an extraction scheme, which may be implemented to extract range and speed (Doppler) estimations from digital reception radar data values, in accordance with some demonstrative aspects. For example, radar processor 104 (FIG. 1), radar processor 210 (FIG. 2), radar processor 309 (FIG. 3), and/or radar processor 402 (FIG. 4), may be configured to extract range and/or speed (Doppler) estimations from digital reception radar data values according to one or more aspects of the extraction scheme of FIG. 5.

In some demonstrative aspects, as shown in FIG. 5, a radio receive signal, e.g., including echoes of a radio transmit signal, may be received by a receive antenna array 501. The radio receive signal may be processed by a radio radar frontend 502 to generate digital reception data values, e.g., as described above. The radio radar frontend 502 may provide the digital reception data values to a radar processor 503, which may process the digital reception data values to provide radar information, e.g., as described above.

In some demonstrative aspects, the digital reception data values may be represented in the form of a data cube 504. For example, the data cube 504 may include digitized samples of the radio receive signal, which is based on a radio signal transmitted from a transmit antenna and received by M receive antennas. In some demonstrative aspects, for example, with respect to a MIMO implementation, there may be multiple transmit antennas, and the number of samples may be multiplied accordingly.

In some demonstrative aspects, a layer of the data cube 504, for example, a horizontal layer of the data cube 504, may include samples of an antenna, e.g., a respective antenna of the M antennas.

In some demonstrative aspects, data cube 504 may include samples for K chirps. For example, as shown in FIG. 5, the samples of the chirps may be arranged in a so-called “slow time”-direction.

In some demonstrative aspects, the data cube 504 may include L samples, e.g., L=512 or any other number of samples, for a chirp, e.g., per each chirp. For example, as shown in FIG. 5, the samples per chirp may be arranged in a so-called “fast time”-direction of the data cube 504.

In some demonstrative aspects, processor 504 may be configured to determine the range values, Doppler values, and/or Angle of Arrival (AoA) values, e.g., Azimuth values and/or Elevation values, for example, based on FFT techniques, e.g., as described below.

In other aspects, processor 504 may be configured to determine the range values, Doppler values, and/or Angle of Arrival (AoA) values, e.g., Azimuth values and/or Elevation values, for example, based on Super-Resolution (SR) techniques, and/or any other suitable processing technique.

In some demonstrative aspects, radar processor 503 may be configured to process a plurality of samples, e.g., L samples collected for each chirp and for each antenna, by a first FFT. The first FFT may be performed, for example, for each chirp and each antenna, such that a result of the processing of the data cube 504 by the first FFT may again have three dimensions, and may have the size of the data cube 504 while including values for L range bins, e.g., instead of the values for the L sampling times.

In some demonstrative aspects, radar processor 503 may be configured to process the result of the processing of the data cube 504 by the first FFT, for example, by processing the result according to a second FFT along the chirps, e.g., for each antenna and for each range bin.

For example, the first FFT may be in the “fast time” direction, and the second FFT may be in the “slow time” direction.

In some demonstrative aspects, the result of the second FFT may provide, e.g., when aggregated over the antennas, a range/Doppler (R/D) map 505. The R/D map may have FFT peaks 506, for example, including peaks of FFT output values (in terms of absolute values) for certain range/speed combinations, e.g., for range/Doppler bins. For example, a range/Doppler bin may correspond to a range bin and a Doppler bin. For example, radar processor 503 may consider a peak as potentially corresponding to an object, e.g., of the range and speed corresponding to the peak's range bin and speed bin.

In some demonstrative aspects, the extraction scheme of FIG. 5 may be implemented for an FMCW radar, e.g., FMCW radar 400 (FIG. 4), as described above. In other aspects, the extraction scheme of FIG. 5 may be implemented for any other radar type. In one example, the radar processor 503 may be configured to determine a range/Doppler map 505 from digital reception data values of a PMCW radar, an OFDM radar, or any other radar technologies. For example, in adaptive or cognitive radar, the pulses in a frame, the waveform and/or modulation may be changed over time, e.g., according to the environment.

Referring back to FIG. 3, in some demonstrative aspects, receive antenna arrangement 303 may be implemented using a receive antenna array having a plurality of receive antennas (or receive antenna elements). For example, radar processor 309 may be configured to determine an angle of arrival of the received radio signal, e.g., echo 107 (FIG. 1) and/or echo 215 (FIG. 2). For example, radar processor 309 may be configured to determine a direction of a detected object, e.g., with respect to the device/system 301, for example, based on the angle of arrival of the received radio signal, e.g., as described below.

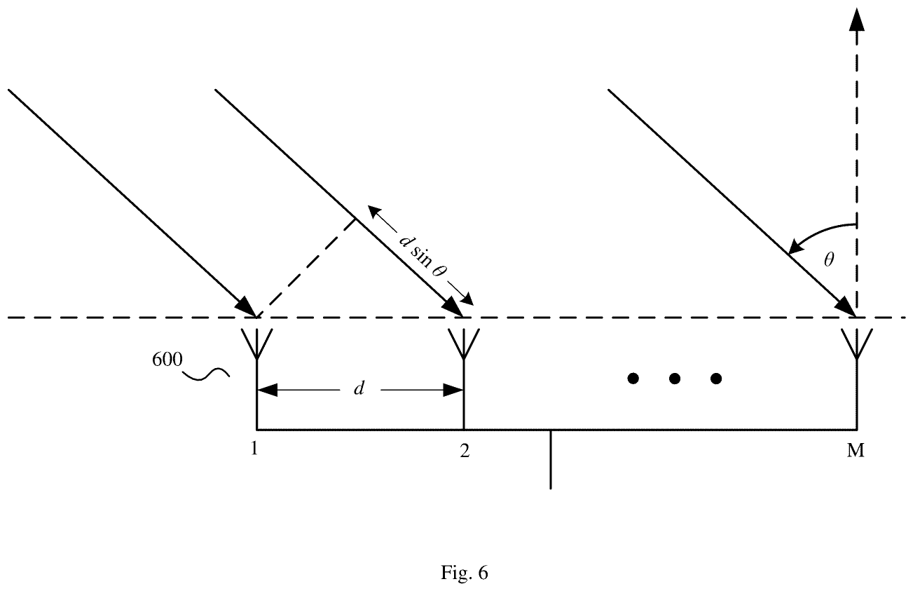

Reference is made to FIG. 6, which schematically illustrates an angle-determination scheme, which may be implemented to determine Angle of Arrival (AoA) information based on an incoming radio signal received by a receive antenna array 600, in accordance with some demonstrative aspects.

FIG. 6 depicts an angle-determination scheme based on received signals at the receive antenna array.

In some demonstrative aspects, for example, in a virtual MIMO array, the angle-determination may also be based on the signals transmitted by the array of Tx antennas.

FIG. 6 depicts a one-dimensional angle-determination scheme. Other multi-dimensional angle determination schemes, e.g., a two-dimensional scheme or a three-dimensional scheme, may be implemented.

In some demonstrative aspects, as shown in FIG. 6, the receive antenna array 600 may include M antennas (numbered, from left to right, 1 to M).

As shown by the arrows in FIG. 6, it is assumed that an echo is coming from an object located at the top left direction. Accordingly, the direction of the echo, e.g., the incoming radio signal, may be towards the bottom right. According to this example, the further to the left a receive antenna is located, the earlier it will receive a certain phase of the incoming radio signal.

For example, a phase difference, denoted Δφ, between two antennas of the receive antenna array 600 may be determined, e.g., as follows:

$$Δφ = \frac{2 π}{λ} \cdot d \cdot sin ( θ )$$

wherein λ denotes a wavelength of the incoming radio signal, d denotes a distance between the two antennas, and θ denotes an angle of arrival of the incoming radio signal, e.g., with respect to a normal direction of the array.

In some demonstrative aspects, radar processor 309 (FIG. 3) may be configured to utilize this relationship between phase and angle of the incoming radio signal, for example, to determine the angle of arrival of echoes, for example, by performing an FFT, e.g., a third FFT (“angular FFT”) over the antennas.

In some demonstrative aspects, multiple transmit antennas, e.g., in the form of an antenna array having multiple transmit antennas, may be used, for example, to increase the spatial resolution, e.g., to provide high-resolution radar information. For example, a MIMO radar device may utilize a virtual MIMO radar antenna, which may be formed as a convolution of a plurality of transmit antennas convolved with a plurality of receive antennas.

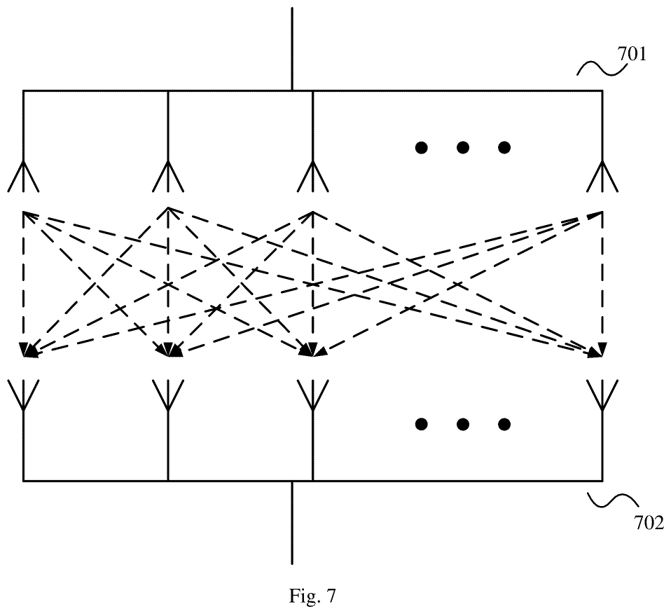

Reference is made to FIG. 7, which schematically illustrates a MIMO radar antenna scheme, which may be implemented based on a combination of Transmit (Tx) and Receive (Rx) antennas, in accordance with some demonstrative aspects.

In some demonstrative aspects, as shown in FIG. 7, a radar MIMO arrangement may include a transmit antenna array 701 and a receive antenna array 702. For example, the one or more transmit antennas 302 (FIG. 3) may be implemented to include transmit antenna array 701, and/or the one or more receive antennas 303 (FIG. 3) may be implemented to include receive antenna array 702.

In some demonstrative aspects, antenna arrays including multiple antennas both for transmitting the radio transmit signals and for receiving echoes of the radio transmit signals, may be utilized to provide a plurality of virtual channels as illustrated by the dashed lines in FIG. 7. For example, a virtual channel may be formed as a convolution, for example, as a Kronecker product, between a transmit antenna and a receive antenna, e.g., representing a virtual steering vector of the MIMO radar.

In some demonstrative aspects, a transmit antenna, e.g., each transmit antenna, may be configured to send out an individual radio transmit signal, e.g., having a phase associated with the respective transmit antenna.

For example, an array of N transmit antennas and M receive antennas may be implemented to provide a virtual MIMO array of size N×M. For example, the virtual MIMO array may be formed according to the Kronecker product operation applied to the Tx and Rx steering vectors.

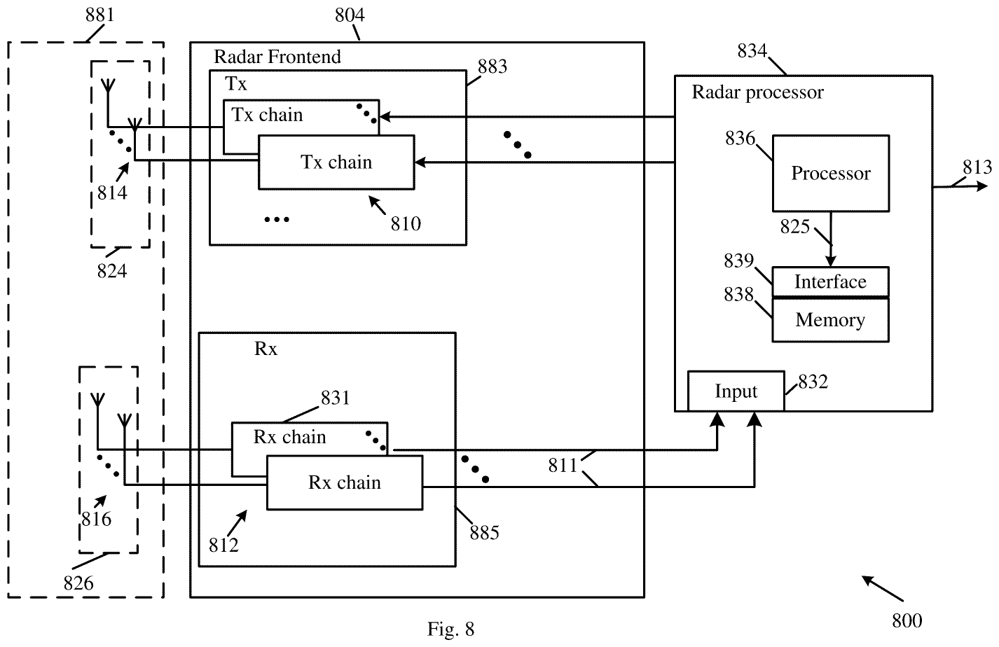

FIG. 8 is a schematic block diagram illustration of elements of a radar device 800, in accordance with some demonstrative aspects. For example, radar device 101 (FIG. 1), radar device 300 (FIG. 3), and/or radar device 400 (FIG. 4), may include one or more elements of radar device 800, and/or may perform one or more operations and/or functionalities of radar device 800.

In some demonstrative aspects, as shown in FIG. 8, radar device 800 may include a radar frontend 804 and a radar processor 834. For example, radar frontend 103 (FIG. 1), radar frontend 211 (FIG. 1), radar frontend 304 (FIG. 3), radar frontend 401 (FIG. 4), and/or radar frontend 502 (FIG. 5), may include one or more elements of radar frontend 804, and/or may perform one or more operations and/or functionalities of radar frontend 804.

In some demonstrative aspects, radar frontend 804 may be implemented as part of a MIMO radar utilizing a MIMO radar antenna 881 including a plurality of Tx antennas 814 configured to transmit a plurality of Tx RF signals (also referred to as “Tx radar signals”); and a plurality of Rx antennas 816 configured to receive a plurality of Rx RF signals (also referred to as “Rx radar signals”), for example, based on the Tx radar signals, e.g., as described below.

In some demonstrative aspects, MIMO antenna array 881, antennas 814, and/or antennas 816 may include or may be part of any type of antennas suitable for transmitting and/or receiving radar signals. For example, MIMO antenna array 881, antennas 814, and/or antennas 816, may be implemented as part of any suitable configuration, structure, and/or arrangement of one or more antenna elements, components, units, assemblies, and/or arrays. For example, MIMO antenna array 881, antennas 814, and/or antennas 816, may be implemented as part of a phased array antenna, a multiple element antenna, a set of switched beam antennas, and/or the like. In some aspects, MIMO antenna array 881, antennas 814, and/or antennas 816, may be implemented to support transmit and receive functionalities using separate transmit and receive antenna elements. In some aspects, MIMO antenna array 881, antennas 814, and/or antennas 816, may be implemented to support transmit and receive functionalities using common and/or integrated transmit/receive elements.

In some demonstrative aspects, MIMO radar antenna 881 may include a rectangular MIMO antenna array, and/or curved array, e.g., shaped to fit a vehicle design.

In other aspects, any other form, shape, and/or arrangement of MIMO radar antenna 881 may be implemented.

In some demonstrative aspects, radar frontend 804 may include one or more radios configured to generate and transmit the Tx RF signals via Tx antennas 814; and/or to process the Rx RF signals received via Rx antennas 816, e.g., as described below.

In some demonstrative aspects, radar frontend 804 may include at least one transmitter (Tx) 883 including circuitry and/or logic configured to generate and/or transmit the Tx radar signals via Tx antennas 814.

In some demonstrative aspects, radar frontend 804 may include at least one receiver (Rx) 885 including circuitry and/or logic to receive and/or process the Rx radar signals received via Rx antennas 816, for example, based on the Tx radar signals.

In some demonstrative aspects, transmitter 883, and/or receiver 885 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like.

In some demonstrative aspects, transmitter 883 may include a plurality of Tx chains 810 configured to generate and transmit the Tx RF signals via Tx antennas 814, e.g., respectively; and/or receiver 885 may include a plurality of Rx chains 812 configured to receive and process the Rx RF signals received via the Rx antennas 816, e.g., respectively.

In some demonstrative aspects, radar processor 834 may be configured to generate radar information 813, for example, based on the radar signals communicated by MIMO radar antenna 881, e.g., as described below. For example, radar processor 104 (FIG. 1), radar processor 210 (FIG. 2), radar processor 309 (FIG. 3), radar processor 402 (FIG. 4), and/or radar processor 503 (FIG. 5), may include one or more elements of radar processor 834, and/or may perform one or more operations and/or functionalities of radar processor 834.

In some demonstrative aspects, radar processor 834 may be configured to generate radar information 813, for example, based on radar Rx data 811 received from the plurality of Rx chains 812. For example, radar Rx data 811 may be based on the radar Rx signals received via the Rx antennas 816.

In some demonstrative aspects, radar processor 834 may include an input 832 to receive radar input data, e.g., including the radar Rx data 811 from the plurality of Rx chains 812.

In some demonstrative aspects, radar processor 834 may include, or may be implemented, partially or entirely, by circuitry and/or logic, e.g., one or more processors including circuitry and/or logic, memory circuitry and/or logic. Additionally or alternatively, one or more functionalities of radar processor 834 may be implemented by logic, which may be executed by a machine and/or one or more processors, e.g., as described below.

In some demonstrative aspects, radar processor 834 may include at least one processor 836, which may be configured, for example, to process the radar Rx data 811, and/or to perform one or more operations, methods, and/or algorithms.

In some demonstrative aspects, radar processor 834 may include at least one memory 838, e.g., coupled to the processor 836. For example, memory 838 may be configured to store data processed by radar processor 834. For example, memory 838 may store, e.g., at least temporarily, at least some of the information processed by the processor 836, and/or logic to be utilized by the processor 836.

In some demonstrative aspects, processor 836 may interface with memory 838, for example, via a memory interface 839.

In some demonstrative aspects, processor 836 may be configured to access memory 838, e.g., to write data to memory 838 and/or to read data from memory 838, for example, via memory interface 839.

In some demonstrative aspects, memory 838 may be configured to store at least part of the radar data, e.g., some of the radar Rx data or all of the radar Rx data, for example, for processing by processor 836, e.g., as described below.

In some demonstrative aspects, memory 838 may be configured to store processed data, which may be generated by processor 836, for example, during the process of generating the radar information 813, e.g., as described below.

In some demonstrative aspects, memory 838 may be configured to store range information and/or Doppler information, which may be generated by processor 836, for example, based on the radar Rx data. In one example, the range information and/or Doppler information may be determined based on a Cross-Correlation (XCORR) operation, which may be applied to the radar Rx data. Any other additional or alternative operation, algorithm, and/or procedure may be utilized to generate the range information and/or Doppler information.

In some demonstrative aspects, memory 838 may be configured to store AoA information, which may be generated by processor 836, for example, based on the radar Rx data, the range information and/or Doppler information. In one example, the AoA information may be determined based on an AoA estimation algorithm. Any other additional or alternative operation, algorithm, and/or procedure may be utilized to generate the AoA information.

In some demonstrative aspects, radar processor 834 may be configured to generate the radar information 813 including one or more of range information, Doppler information, and/or AoA information.

In some demonstrative aspects, the radar information 813 may include Point Cloud 1 (PC1) information, for example, including raw point cloud estimations, e.g., Range, Radial Velocity, Azimuth, and/or Elevation.

In some demonstrative aspects, the radar information 813 may include Point Cloud 2 (PC2) information, which may be generated, for example, based on the PC1 information. For example, the PC2 information may include clustering information, tracking information, e.g., tracking of probabilities and/or density functions, bounding box information, classification information, orientation information, and the like.

In some demonstrative aspects, the radar information 813 may include target tracking information corresponding to a plurality of targets in an environment of the radar device 800, e.g., as described below.

In some demonstrative aspects, radar processor 834 may be configured to generate the radar information 813 in the form of four Dimensional (4D) image information, e.g., a cube, which may represent 4D information corresponding to one or more detected targets.

In some demonstrative aspects, the 4D image information may include, for example, range values, e.g., based on the range information, velocity values, e.g., based on the Doppler information, azimuth values, e.g., based on azimuth AoA information, elevation values, e.g., based on elevation AoA information, and/or any other values.

In some demonstrative aspects, radar processor 834 may be configured to generate the radar information 813 in any other form, and/or including any other additional or alternative information.

In some demonstrative aspects, radar processor 834 may be configured to process the signals communicated via MIMO radar antenna 881 as signals of a virtual MIMO array formed by a convolution of the plurality of Rx antennas 816 and the plurality of Tx antennas 814.

In some demonstrative aspects, radar frontend 804 and/or radar processor 834 may be configured to utilize MIMO techniques, for example, to support a reduced physical array aperture, e.g., an array size, and/or utilizing a reduced number of antenna elements. For example, radar frontend 804 and/or radar processor 834 may be configured to transmit orthogonal signals via one or more Tx arrays 824 including a plurality of N elements, e.g., Tx antennas 814, and processing received signals via one or more Rx arrays 826 including a plurality of M elements, e.g., Rx antennas 816.

In some demonstrative aspects, utilizing the MIMO technique of transmission of the orthogonal signals from the Tx arrays 824 with N elements and processing the received signals in the Rx arrays 826 with M elements may be equivalent, e.g., under a far field approximation, to a radar utilizing transmission from one antenna and reception with N*M antennas. For example, radar frontend 804 and/or radar processor 834 may be configured to utilize MIMO antenna array 881 as a virtual array having an equivalent array size of N*M, which may define locations of virtual elements, for example, as a convolution of locations of physical elements, e.g., the antennas 814 and/or 816.

In some demonstrative aspects, a radar system may include a plurality of radar devices 800. For example, vehicle 100 (FIG. 1) may include a plurality of radar devices 800, e.g., as described below.

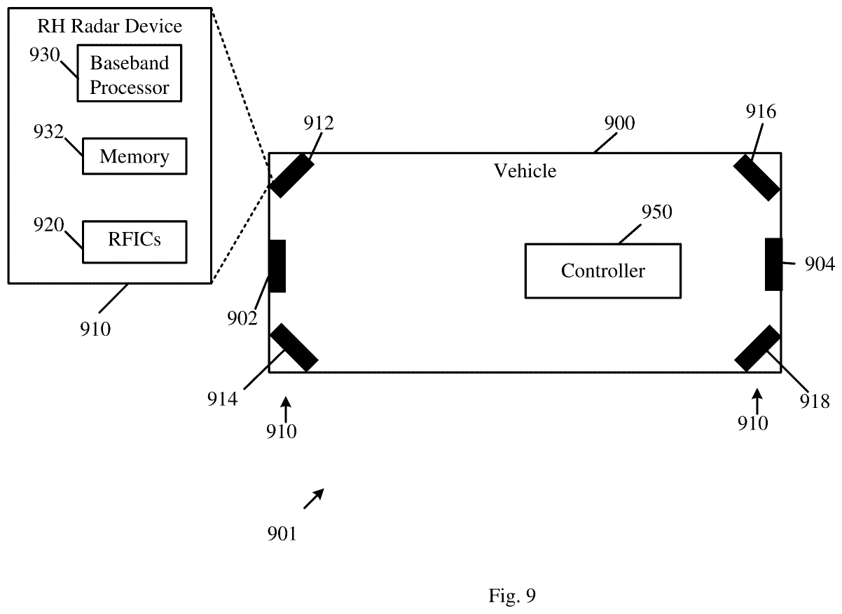

Reference is made to FIG. 9, which schematically illustrates a radar system 901 including a plurality of Radio Head (RH) radar devices (also referred to as RHs) 910 implemented in a vehicle 900, in accordance with some demonstrative aspects.

In some demonstrative aspects, as shown in FIG. 9, the plurality of RH radar devices 910 may be located, for example, at a plurality of positions around vehicle 900, for example, to provide radar sensing at a large field of view around vehicle 900, e.g., as described below.

In some demonstrative aspects, as shown in FIG. 9, the plurality of RH radar devices 910 may include, for example, six RH radar devices 910, e.g., as described below.

In some demonstrative aspects, the plurality of RH radar devices 910 may be located, for example, at a plurality of positions around vehicle 900, which may be configured to support 360-degrees radar sensing, e.g., a field of view of 360 degrees surrounding the vehicle 900, e.g., as described below.

In one example, the 360-degrees radar sensing may allow to provide a radar-based view of substantially all surroundings around vehicle 900, e.g., as described below.

In other aspects, the plurality of RH radar devices 910 may include any other number of RH radar devices 910, e.g., less than six radar devices or more than six radar devices.

In other aspects, the plurality of RH radar devices 910 may be positioned at any other locations and/or according to any other arrangement, which may support radar sensing at any other field of view around vehicle 900, e.g., 360-degrees radar sensing or radar sensing of any other field of view.

In some demonstrative aspects, as shown in FIG. 9, vehicle 900 may include a first RH radar device 902, e.g., a front RH, at a front-side of vehicle 900.

In some demonstrative aspects, as shown in FIG. 9, vehicle 900 may include a second RH radar device 904, e.g., a back RH, at a back-side of vehicle 900.

In some demonstrative aspects, as shown in FIG. 9, vehicle 900 may include one or more of RH radar devices at one or more respective corners of vehicle 900. For example, vehicle 900 may include a first corner RH radar device 912 at a first corner of vehicle 900, a second corner RH radar device 914 at a second corner of vehicle 900, a third corner RH radar device 916 at a third corner of vehicle 900, and/or a fourth corner RH radar device 918 at a fourth corner of vehicle 900.

In some demonstrative aspects, vehicle 900 may include one, some, or all, of the plurality of RH radar devices 910 shown in FIG. 9. For example, vehicle 900 may include the front RH radar device 902 and/or back RH radar device 904.

In other aspects, vehicle 900 may include any other additional or alternative radar devices, for example, at any other additional or alternative positions around vehicle 900. In one example, vehicle 900 may include a side radar, e.g., on a side of vehicle 900.

In some demonstrative aspects, as shown in FIG. 9, vehicle 900 may include a radar system controller 950 configured to control one or more, e.g., some or all, of the RH radar devices 910.

In some demonstrative aspects, at least part of the functionality of radar system controller 950 may be implemented by a dedicated controller, e.g., a dedicated system controller or central controller, which may be separate from the RH radar devices 910, and may be configured to control some or all of the RH radar devices 910.

In some demonstrative aspects, at least part of the functionality of radar system controller 950 may be implemented as part of at least one RH radar device 910.

In some demonstrative aspects, at least part of the functionality of radar system controller 950 may be implemented by a radar processor of an RH radar device 910. For example, radar processor 834 (FIG. 8) may include one or more elements of radar system controller 950, and/or may perform one or more operations and/or functionalities of radar system controller 950.

In some demonstrative aspects, at least part of the functionality of radar system controller 950 may be implemented by a system controller of vehicle 900. For example, vehicle controller 108 (FIG. 1) may include one or more elements of radar system controller 950, and/or may perform one or more operations and/or functionalities of radar system controller 950.

In other aspects, one or more functionalities of system controller 950 may be implemented as part of any other element of vehicle 900.

In some demonstrative aspects, as shown in FIG. 9, an RH radar device 910 of the plurality of RH radar devices 910, may include a baseband processor 930 (also referred to as a “Baseband Processing Unit (BPU)”), which may be configured to control communication of radar signals by the RH radar device 910, and/or to process radar signals communicated by the RH radar device 910. For example, baseband processor 930 may include one or more elements of radar processor 834 (FIG. 8), and/or may perform one or more operations and/or functionalities of radar processor 834 (FIG. 8).

In other aspects, an RH radar device 910 of the plurality of RH radar devices 910 may exclude one or more, e.g., some or all, functionalities of baseband processor 930. For example, controller 950 may be configured to perform one or more, e.g., some or all, functionalities of the baseband processor 930 for the RH.

In one example, controller 950 may be configured to perform baseband processing for all RH radar devices 910, and all RH radio devices 910 may be implemented without baseband processors 930.

In another example, controller 950 may be configured to perform baseband processing for one or more first RH radar devices 910, and the one or more first RH radio devices 910 may be implemented without baseband processors 930; and/or one or more second RH radar devices 910 may be implemented with one or more functionalities, e.g., some or all functionalities, of baseband processors 930.

In another example, one or more, e.g., some or all, RH radar devices 910 may be implemented with one or more functionalities, e.g., partial functionalities or full functionalities, of baseband processors 930.

In some demonstrative aspects, baseband processor 930 may include one or more components and/or elements configured for digital processing of radar signals communicated by the RH radar device 910, e.g., as described below.

In some demonstrative aspects, baseband processor 930 may include one or more FFT engines, matrix multiplication engines, DSP processors, and/or any other additional or alternative baseband, e.g., digital, processing components.

In some demonstrative aspects, as shown in FIG. 9, RH radar device 910 may include a memory 932, which may be configured to store data processed by, and/or to be processed by, baseband processor 930. For example, memory 932 may include one or more elements of memory 838 (FIG. 8), and/or may perform one or more operations and/or functionalities of memory 838 (FIG. 8).

In some demonstrative aspects, memory 932 may include an internal memory, and/or an interface to one or more external memories, e.g., an external Double Data Rate (DDR) memory, and/or any other type of memory.

In other aspects, an RH radar device 910 of the plurality of RH radar devices 910 may exclude memory 932. For example, the RH radar device 910 may be configured to provide radar data to controller 950, e.g., in the form of raw radar data.

In some demonstrative aspects, as shown in FIG. 9, RH radar device 910 may include one or more RF units, e.g., in the form of one or more RF Integrated Chips (RFICs) 920, which may be configured to communicate radar signals, e.g., as described below.

For example, an RFIC 920 may include one or more elements of front-end 804 (FIG. 8), and/or may perform one or more operations and/or functionalities of front-end 804 (FIG. 8).

In some demonstrative aspects, the plurality of RFICs 920 may be operable to form a radar antenna array including one or more Tx antenna arrays and one or more Rx antenna arrays.

For example, the plurality of RFICs 920 may be operable to form MIMO radar antenna 881 (FIG. 8) including Tx arrays 824 (FIG. 8), and/or Rx arrays 826 (FIG. 8).

In some demonstrative aspects, the plurality of RH radar devices 910 may be installed, for example, as integrated units around vehicle 900, for example, in the front, the rear, and/or corners of vehicle 900. For example, the plurality of RH radar devices 910 may be installed at a low position, e.g., at a bumper level of a bumper of vehicle 900, and/or or at a high position, e.g., on top of the vehicle 900, for example, on a roof of the vehicle.

In one example, radar devices may be positioned at dedicated high positions on vehicle 900, for example, to allow long-range detection and/or a clear Field of View (FoV).

In some demonstrative aspects, some radar devices and/or radar systems, e.g., radar system 901 and/or radar device 800 (FIG. 8), may be implemented as, and/or may be configured to perform one or more operations and/or functionalities of, a Software Defined Radar (SDR), e.g., as described below.

In some demonstrative aspects, some radar devices and/or radar systems, e.g., radar system 901 and/or radar device 800 (FIG. 8), may be implemented as, and/or may be configured to perform one or more operations and/or functionalities of, an imaging radar device, e.g., as described below.

For example, some implementations of an imaging radar device may include a relatively complex system, for example, including a plurality of SoCs, e.g., multiple SoCs.

For example, in some implementations, an imaging radar device may include relatively advanced RF capabilities, relatively advanced analog capabilities, and/or relatively advanced compute capabilities, e.g., compared to a non-imaging radar device.

For example, radar devices for vehicles may be required to meet one or more Functional Safety (FuSa) requirements, e.g., industry FuSa requirements.

In one example, radar devices for vehicles may be required to meet at least an Automotive Safety Integrity Level B (ASIL-B) functional safety requirement.

For example, a certification process for FuSa of radar devices may become highly challenging, for example, in order to be able to ensure that a required fault coverage and/or low Fault In Time (FIT) is reached, for example, in compliance with one or more standards, e.g., an ISO 26262 standard.

In one example, a certification process for FuSa of an imaging radar device may become highly challenging, for example, in case the imaging radar device includes a complex imaging radar system, for example, including a mixture of high-end RF and analog silicon, e.g., combined with digital processing silicon.

In some demonstrative aspects, there may be a need to address one or more technical issues when implementing a FuSa solution to comply with FuSa requirements for complex computation systems, e.g., involving real time computations, e.g., as described below.

For example, in some use cases, scenarios and/or implementations there may be one or more technical problems, disadvantages, and/or inefficiencies in implementations utilizing redundant components, e.g., redundant hardware components and/or software components, for complying with FuSa requirements.

For example, in many use cases it may be inefficient to implement hardware redundancy, e.g., by duplicating one or more HW blocks, and/or software redundancy, e.g., by duplicating one or more code blocks, for example, for complex systems.

In one example, implementing hardware redundancy and/or software redundancy in order to comply with FuSa requirements for a complex compute radar device may result in a significant overhead, for example, in terms of area, cost, power consumption, and/or latency.

For example, duplicating one or more HW blocks, and/or one or more software or code blocks in order to comply with FuSa requirements for complex compute radar systems, may result in a significant increase, e.g., by tens of percents, for example, in a size of a product, a cost of the product, and/or a power consumption of the product.

In one example, a complex compute radar device may include a relatively large antenna array, e.g., a 256-elements antenna array or any other antenna array, which may be implemented by a combination of a plurality of radar Tx channels, e.g., 16 Tx channels or any other number of Tx radar channels, multiplied by a plurality of Rx radar channels, e.g., 16 Rx channels or any other number of Rx radar channels.

For example, an implementation of an analog frontend and a digital frontend of a radar channel may have a silicon size of about 2-10 mm² or any other suitable size, e.g., depending on architecture.

According to this example, duplicating HW blocks, e.g., by duplicating the Tx radar channels and/or the Rx radar channels, may result in a large increase of the silicon size, e.g., to about 2×16-32 mm², which may require double power consumption.

In some demonstrative aspects, there may be a need to address one or more technical issues for ensuring compliance with FuSa requirements for complex analog radar devices, which may utilize analog components.

In one example, it may be relatively hard and/or complex to detect faults in analog components, for example, utilizing common digital methods.

For example, it may still be required to duplicate many analog blocks, and/or to use expensive dedicated monitor elements, for example, in order to ensure FuSa compliance. For example, the duplicated analog blocks and/or the dedicated monitoring elements may result in a significant increase in silicon size and/or power consumption.

In some demonstrative aspects, a radar system, e.g., radar system 901, and/or a radar device, e.g., radar device 800 (FIG. 8), may be configured to implement one or more operations and/or functionalities of a FuSa mechanism, which may be configured to provide a technical solution to confirm safeness of an imaging radar device, e.g., as described below.

In some demonstrative aspects, the FuSa mechanism may be configured, for example, to provide a technical solution to ensure safeness of an imaging radar device, for example, a complex analog radar device, including one or more analog components, e.g., as described below.

In some demonstrative aspects, the FuSa mechanism may be configured, for example, to provide a technical solution to ensure safeness of an imaging radar device, for example, a complex compute radar device, utilizing large and/or complex computations, e.g., as described below.

In some demonstrative aspects, the FuSa mechanism may be configured, for example, to provide a technical solution to detect FuSa events of the imaging radar device, e.g., as described below.

In some demonstrative aspects, the FuSa events may include, for example, FuSa faults, non-safe states, FuSa errors, safety errors, and/or any other event which may affect the functional safety of the imaging radar device.

In some demonstrative aspects, the FuSa events may include, for example, events, which may be defined, for example, in accordance with requirements of one or more FuSa Standards and/or Specifications.

In some demonstrative aspects, the FuSa mechanism may be configured, for example, to provide a technical solution to support detection of FuSa events, for example, over one or more components, e.g., some or all components, of the imaging radar device, e.g., as described below.

In some demonstrative aspects, the FuSa mechanism may be configured, for example, to provide a technical solution to support detection of FuSa events, for example, over an entire system, e.g., of an entire end to end (E2E) system, of the imaging radar device, e.g., as described below.

In some demonstrative aspects, the FuSa mechanism may be configured, for example, to provide a technical solution utilizing a radar compute path of an imaging radar device, for example, to monitor and/or detect the FuSa events for the imaging radar device, e.g., as described below.

In some demonstrative aspects, the FuSa mechanism may be configured, for example, to provide a technical solution utilizing the radar compute path of the imaging radar device together with one or more metrics of the radar compute path, for example, to monitor and/or detect the FuSa events for the imaging radar device, e.g., as described below.

In some demonstrative aspects, the FuSa mechanism may be configured, for example, to provide a technical solution to utilize by-products of the radar compute path of the imaging radar device, for example, to detect the FuSa events, e.g., as described below.

In some demonstrative aspects, the FuSa mechanism may be configured, for example, to provide a technical solution to reuse one or more components and/or by-products of the radar compute path of the imaging radar device, for example, to detect the FuSa events, e.g., as described below.

In some demonstrative aspects, the FuSa mechanism may be configured, for example, to provide a technical solution to detect FuSa events, which may impact one or more Key Performance Indicators (KPIs) of the imaging radar device, e.g., as described below.

In some demonstrative aspects, the FuSa mechanism may be configured, for example, to provide a technical solution to utilize by-products of the radar compute path, for example, to detect one or more faults, which may have impact on one or more KPIs, and, accordingly, to detect non-safe events, e.g., with a relatively good level of coverage.

In some demonstrative aspects, the FuSa mechanism may be configured, for example, to provide a technical solution to ensure FuSa of the imaging radar device, for example, while avoiding duplication of hardware and/or software components, e.g., as described below.

In some demonstrative aspects, the FuSa mechanism may be configured, for example, to provide a technical solution to detect FuSa events of the imaging radar device, for example, with good coverage, e.g., an E2E coverage, of the imaging radar device, e.g., as described below.

In some demonstrative aspects, the FuSa mechanism may be configured to provide a technical solution to ensure the FuSa of digital and analog blocks of the imaging radar device, for example, by reusing a functional flow of the imaging radar device, e.g., as described below.

In some demonstrative aspects, the FuSa mechanism may be configured, for example, to provide a technical solution to ensure FuSa of digital blocks and/or analog blocks of an imaging radar device, e.g., with high coverage, for example, with reduced, e.g., minimal, impact on an area, cost and/or power consumption of the imaging radar device, e.g., as described below.

In some demonstrative aspects, a radar system, e.g., radar system 901, and/or a radar device, e.g., radar device 800 (FIG. 8), may include a FuSa detector, which may be configured to implement one or more functionalities and/or operations according to the FuSa mechanism, e.g., as described below.

In some demonstrative aspects, the FuSa detector may be configured to ensure and/or confirm FuSa of the radar system, e.g., radar system 901, and/or the radar device, e.g., radar device 800 (FIG. 8), e.g., as described below.

In some demonstrative aspects, the FuSa detector may be configured to detect FuSa events of an imaging radar processing path including a plurality of radar processing stages of the radar system, e.g., as described below.

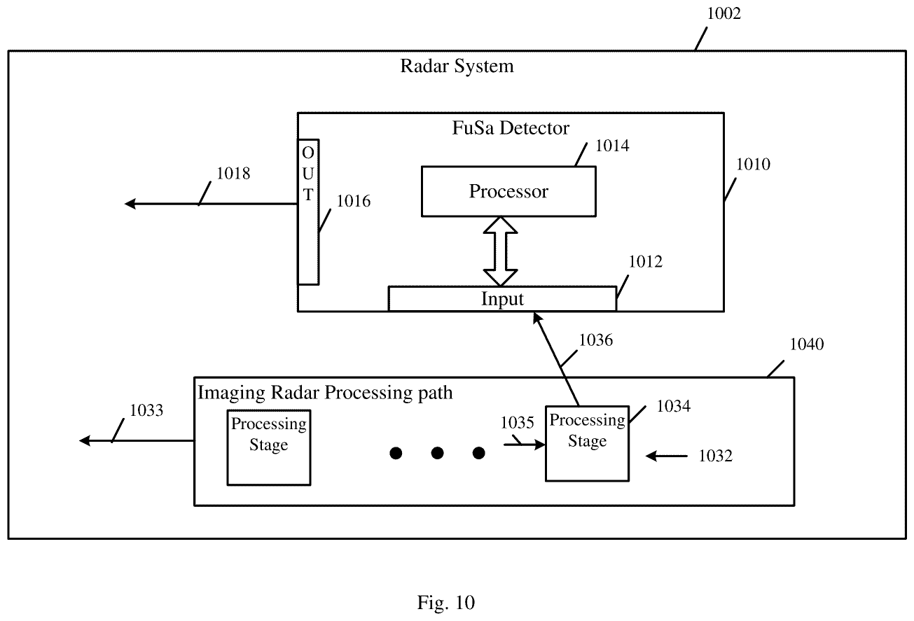

Reference is made to FIG. 10, which schematically illustrates a radar system 1000, in accordance with some demonstrative aspects. For example, radar system 901 (FIG. 9) and/or radar device 800 (FIG. 8) may include one or more elements of radar system 1000, and/or may perform one or more operations and/or functionalities of radar system 1000.

In some demonstrative aspects, radar system 1000 may include an imaging radar device, e.g., as described below.

In some demonstrative aspects, radar system 1000 may include an SDR, e.g., as described below.

In other aspects, radar system 1000 may include any other type of radar device and/or system.

In some demonstrative aspects, as shown in FIG. 10, radar system 1000 may include a FuSa detector 1010, which may be configured to detect FuSa events of an imaging radar processing path 1040, e.g., as described below.

In some demonstrative aspects, imaging radar processing path 1040 may include a plurality of radar processing stages 1032, e.g., as described below.

In some demonstrative aspects, the plurality of radar processing stages 1032 may be configured to generate radar information 1033, for example, based on transmission of radar transmit Tx signals, and processing of radar Rx signals, e.g., as described below.

In some demonstrative aspects, the radar Rx signals may be based, for example, on the radar Tx signals, e.g., as described below.

In one example, the plurality of radar processing stages 1032 may be configured to generate radar information 813 (FIG. 8), for example, based on transmission of the radar transmit Tx signals, e.g., via Tx antennas 814 (FIG. 8), and processing of radar Rx signals, e.g., via Rx antennas 816 (FIG. 8), for example, based on the radar Tx signals, e.g., as described below.

In some demonstrative aspects, the plurality of radar processing stages 1032 may include, for example, a digital Tx frontend processing stage, which may be configured to generate Tx digital signals, e.g., as described below.

In some demonstrative aspects, the plurality of radar processing stages 1032 may include, for example, an analog Tx frontend processing stage, which may be configured to transmit the radar Tx signals, for example, based on the digital Tx signals, e.g., as described below.

In some demonstrative aspects, the plurality of radar processing stages 1032 may include, for example, an analog Rx frontend processing stage, which may be configured to process the radar Rx signals, e.g., as described below.

In some demonstrative aspects, the plurality of radar processing stages 1032 may include, for example, a digital Rx frontend processing stage, which may be configured to generate digital radar Rx signals, for example, based on the radar Rx signals, e.g., as described below.

In some demonstrative aspects, the plurality of radar processing stages 1032 may include, for example, a range processing stage, for example, a matched filter processing stage, which may be configured to generate information of a plurality of range bins, for example, based on the digital radar Rx signals, e.g., as described below.

In some demonstrative aspects, the plurality of radar processing stages 1032 may include, for example, a Doppler processing stage, which may be configured to generate Doppler information, e.g., in the form of a range-Doppler (RD) map, for example, based on the information of the plurality of range bins, e.g., as described below.

In some demonstrative aspects, the plurality of radar processing stages 1032 may include, for example, an Angle of Arrival (AoA) processing stage, which may be configured to generate AoA information, e.g., in the form of an AoA map, for example, based on the RD map, e.g., as described below.

In some demonstrative aspects, the plurality of radar processing stages 1032 may include, for example, a processing stage, which may be configured to process the AoA map, e.g., as described below.

In some demonstrative aspects, the plurality of radar processing stages 1032 may include, for example, a target detection stage, which may be configured to detect one or more targets, for example, based on the AoA map, e.g., as described below.

In other aspects, the plurality of radar processing stages 1032 may include any other additional and/or alternative processing stages.

In some demonstrative aspects, FuSa detector 1010 may include an input 1012, which may be configured to receive a digital output 1036 of a radar processing stage 1034 of the imaging radar processing path 1040, e.g., as described below.

In some demonstrative aspects, FuSa detector 1010 may include a processor 1014, which may be configured to monitor the digital output 1036, e.g., as described below.

In some demonstrative aspects, processor 1014 may be configured to detect a FuSa event, for example, based on current data in the digital output 1036, and reference information corresponding to the radar processing stage 1034, e.g., as described below.

In some demonstrative aspects, FuSa detector 1010 may include an output 1016, which may be configured to provide a FuSa alert 1018, for example, to indicate detection of the FuSa event, e.g., as described below.

In some demonstrative aspects, the reference information corresponding to the radar processing stage 1034 may represent expected data in the digital output 1036 of the radar processing stage 1034, for example, when no FuSa event is to be detected, e.g., as described below.

In some demonstrative aspects, the reference information corresponding to the radar processing stage 1034 may be based, for example, on previous data in the digital output 1036, e.g., as described below.

In some demonstrative aspects, the previous data in the digital output 1036 may include a previous value of a predefined parameter in the digital output 1036, e.g., as described below.

In some demonstrative aspects, processor 1014 may be configured to identify a current value of the predefined parameter in the digital output 1036, e.g., as described below.

In some demonstrative aspects, processor 1014 may be configured to detect the FuSa event, for example, based on a comparison between the current value of the predefined parameter and the previous value of the predefined parameter, e.g., as described below.

In some demonstrative aspects, processor 1014 may be configured to detect the FuSa event, for example, based on a difference between the current value of the predefined parameter and the previous value of the predefined parameter, e.g., as described below.

In some demonstrative aspects, processor 1014 may be configured to generate the FuSa alert 1018, for example, based on a determination that the difference between the current value of the predefined parameter and the previous value of the predefined parameter is greater than a difference threshold, e.g., as described below.

In some demonstrative aspects, processor 1014 may be configured to select not to generate the FuSa alert 1018, for example, based on a determination that the difference between the current value of the predefined parameter and the previous value of the predefined parameter does not exceed the difference threshold, e.g., as described below.

In some demonstrative aspects, the reference information may include a reference digital signature, e.g., as described below.

In other aspects, the reference information may include any other additional and/or alternative information.

In some demonstrative aspects, processor 1014 may be configured to identify a current digital signature in the current data of the digital output 1036, e.g., as described below.

In some demonstrative aspects, processor 1014 may be configured to detect the FuSa event, for example, based on a comparison between the current digital signature and the reference digital signature, e.g., as described below.

In some demonstrative aspects, processor 1014 may be configured to generate the FuSa alert 1018, for example, based on a determination that the current digital signature and the reference digital signature do not match, e.g., as described below.

In some demonstrative aspects, processor 1014 may be configured to select not to generate the FuSa alert 1018, for example, based on a determination that the current digital signature matches the reference digital signature, e.g., as described below.

In some demonstrative aspects, the reference digital signature may be based, for example, on a predefined digital signature to be applied to a digital input 1035 of the radar processing stage 1034, e.g., as described below.

In some demonstrative aspects, FuSa detector 1010 may include a pattern generator (not shown in FIG. 10), which may be configured to generate the predefined digital signature, e.g., as described below.

In other aspects, the pattern generator may be implemented as part of any other element of radar system 1000.

In some demonstrative aspects, the pattern generator may be configured to apply the predefined digital signature to a digital input 1035 of the radar processing stage 1034, e.g., as described below.

In some demonstrative aspects, the digital output 1036 of the radar processing stage 1034 may include an output of an ADC (not shown in FIG. 10), for example, based on analog radar signals processed by an analog radar processing stage 1034 of the imaging radar processing path 1040, e.g., as described below.

In some demonstrative aspects, FuSa detector 1010 may be configured according to a FuSa mechanism, which may be configured to confirm safeness of radar system 1000.

In some demonstrative aspects, the FuSa mechanism may include a plurality of Safety Mechanisms (SMs) for the plurality of processing stages 1032 of imaging radar processing path 1040, e.g., as described below.

In some demonstrative aspects, the plurality of SMs may form a FuSa package for an imaging radar device.

In some demonstrative aspects, one or more SMs of the plurality of SMs may be software based, e.g., as described below.

In some demonstrative aspects, one or more SMs of the plurality of SMs may be hardware based, e.g., as described below.

In some demonstrative aspects, one or more SMs of the plurality of SMs may be based on a combination of hardware and software, e.g., as described below.

In some demonstrative aspects, a safety mechanism, e.g., each safety mechanism, of the plurality of SMs may be configured to provide a technical solution to ensure FuSa of a processing stage of imaging radar processing path 1040, e.g., as described below.

In some demonstrative aspects, a safety mechanism, e.g., each safety mechanism, of the plurality of SMs may be based on one or more principles, which may utilize the functional flow of the imaging radar processing path 1040, e.g., as described below.

In some demonstrative aspects, the plurality of SMs may be configured to provide a technical solution to ensure FuSa of the imaging radar processing path 1040, for example, with reduced, e.g., minimal, overhead, e.g., as described below.

In some demonstrative aspects, FuSa detector 1010 may be configured to detect permanent FuSa errors in imaging radar processing path 1040, e.g., as described below.

In one example, detection of the permanent FuSa errors imaging radar processing path 1040 may be performed, for example, offline, e.g., after data has been processed.

In some demonstrative aspects, the permanent FuSa errors may usually contribute about 20% of the FIT.

In some demonstrative aspects, FuSa detector 1010 may be configured to detect transient FuSa errors in imaging radar processing path 1040, e.g., as described below.

In one example, detection of permanent FuSa errors in imaging radar processing path 1040 may be performed, for example, in real time, e.g., during processing of data in imaging radar processing path 1040, e.g., as described below.

In some demonstrative aspects, the transient FuSa errors may usually contribute about 80% of the FIT.

In some demonstrative aspects, the transient FuSa errors may be harder to detect, e.g., compared to the permanent FuSa errors.

In some demonstrative aspects, detection of the transient FuSa errors may be important and/or may be a great challenge, for example, as the transient FuSa errors may be the major contributor to the FIT.

In some demonstrative aspects, detection of the transient FuSa errors may be important and/or may be a great challenge, for example, as the transient FuSa errors may be harder to detect, e.g., since the detection of permanent FuSa errors may be performed in real time.

In some demonstrative aspects, FuSa detector 1010 may be configured to apply the plurality of SMs periodically.

In some demonstrative aspects, the plurality of SMs may be applied under a relatively aggressive Fault Tolerant Time Interval (FTTI).

In some demonstrative aspects, FuSa detector 1010 may be configured to apply the plurality of SMs, for example, under a relatively aggressive FTTI, e.g., of about 100 ms, or any other interval.

In some demonstrative aspects, it may be difficult to utilize complex SMs, for example, when applying the plurality of SMs, e.g., periodically and/or under relatively aggressive FTTI.

In some demonstrative aspects, the plurality of SMs may be configured with reduced complexity, for example, to provide a technical solution to support applying the plurality of SMs periodically and/or under relatively aggressive FTTI, e.g., as described below.

In some demonstrative aspects, one or more, e.g., some or all, of the plurality of SMs may be implemented as part of the compute flow of imaging radar processing path 1040 and/or may have relatively low complexity, for example, to provide a technical solution to avoid wasting of HW resources and/or SW resources, for example, to run the plurality of SMs periodically, e.g., in a cyclic manner.

In some demonstrative aspects, one or more, e.g., some or all, of the plurality of SMs may be utilized, for example, as part of the compute flow of imaging radar processing path 1040, and/or using parameters and/or metrics, which are determined and/or calculated as part of the compute flow, e.g., on the fly, for example, to provide a technical advantage for efficient usage of system resources for FuSa.

In some demonstrative aspects, FuSa detector 1010 may implement a backbone network, for example, to collect faults from one or more, e.g., some or all, of the plurality of processing stages 1032 of imaging radar processing path 1040, for example, into a secure double logic aggregator, e.g., processor 1014, which may report FuSa errors, e.g., when they occur, e.g., as described below.

In some demonstrative aspects, FuSa detector 1010 may be configured to protect one or more HW components of radar processing path 1040, for example, by protecting an entire logic of the HW components. For example, a hardware component may include, logic, a HW accelerator, general purpose DSPs, and/or the like, e.g., as described below.

In some demonstrative aspects, FuSa detector 1010 may be configured to provide a technical solution to achieve an E2E coverage and/or protection, e.g., over imaging radar processing path 1040, for example, by relaying on system flows, which include a complex analytic check that covers many blocks, for example, as SOCs are complicated entities, e.g., as described below.

In one example, the more complicated a check of a processing stage 1032 of the imaging radar processing path 1040 is the easier it may be to check and collect coverage of errors, for example, since an error may significantly impact results of the processing stage.

In some demonstrative aspects, FuSa detector 1010 may be configured to provide a technical solution to exploit a nature characteristic of an SDR, e.g., as described below.

In one example, an SDR may include an imaging radar, e.g., having a relatively big array, which may record a relatively large amount of information, e.g., including a relatively large number of samples in a 4D cube, e.g., about −100-300 million samples. For example, these samples may be averaged together, which may add inherent resilience to the SDR. For example, FuSa detector 1010 may be configured to exploit this feature, for example, to detect FuSa events, e.g., as described below.

In some demonstrative aspects, FuSa detector 1010 may be implemented as part of a radar device or system, for example, as part of radar system 901 (FIG. 9) or radar device 800 (FIG. 8), e.g., as described above.

In some demonstrative aspects, FuSa detector 1010 may be implemented as part of any other suitable device and/or system.

For example, in some demonstrative aspects, FuSa detector 1010 may be implemented as part of a device, for example, a mobile device, a computing device, and/or a wireless communication device, for example, to ensure FuSa of a wireless communication processing path to communicate RF wireless communication signals.

For example, in some demonstrative aspects, FuSa detector 1010 may be implemented to ensure FuSa of a wireless communication processing path to communicate the RF wireless communication signals over mmWave frequencies.

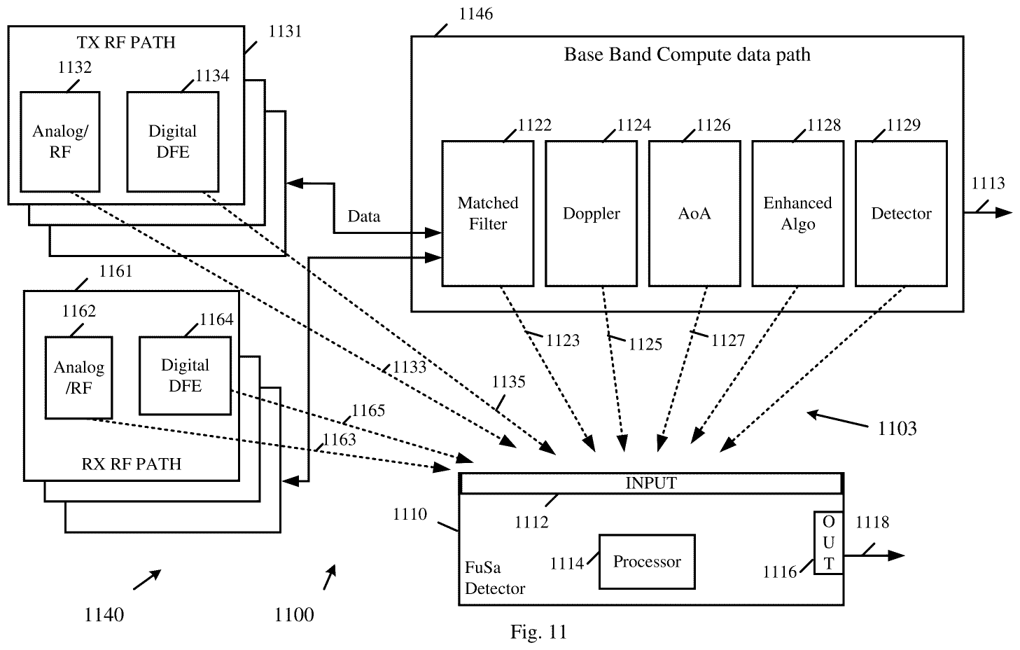

Reference is made to FIG. 11, which schematically illustrates elements of a radar system 1100, in accordance with some demonstrative aspects. For example, radar system 1000 (FIG. 10) may include one or more elements of radar system 1100, and/or may perform one or more operations and/or functionalities of radar system 1100.

In some demonstrative aspects, radar system 1100 may include an imaging radar device.

In some demonstrative aspects, radar system 1100 may include an SDR.

In other aspects, radar system 1100 may include any other type of radar device.

In some demonstrative aspects, as shown in FIG. 11, radar system 1100 may include a FuSa detector 1110, which may be configured to detect FuSa events of an imaging radar processing path 1140, e.g., as described below.

In some demonstrative aspects, imaging radar processing path 1140 may include a plurality of radar processing stages, e.g., as described below.

In some demonstrative aspects, as shown in FIG. 11, imaging radar processing path 1140 may include a Tx processing path 1131, an Rx processing path 1161, and/or a baseband processing path 1146.

In other aspects, imaging radar processing path 1140 may include any other additional and/or alternative processing paths, at any other suitable order.

In some demonstrative aspects, as shown in FIG. 11, Tx processing path 1131 may include a digital Tx frontend processing stage 1134, which may be configured to generate Tx digital signals.

In some demonstrative aspects, as shown in FIG. 11, Tx processing path 1131 may include an analog Tx frontend processing stage 1132, which may be configured to transmit the radar Tx signals, for example, based on the digital Tx signals.

In other aspects, Tx processing path 1131 may include any other additional and/or alternative processing stages.

In some demonstrative aspects, as shown in FIG. 11, Rx processing path 1161 may include an analog Rx frontend processing stage 1162, which may be configured to process radar Rx signals, e.g., received based on the radar Tx signals.

In some demonstrative aspects, as shown in FIG. 11, Rx processing path 1161 may include a digital Rx frontend processing stage 1164, which may be configured to generate digital radar Rx signals, for example, based on the radar Rx signals.

In other aspects, Rx processing path 1161 may include any other additional and/or alternative processing stages.

In some demonstrative aspects, as shown in FIG. 11, baseband processing path 1146 may include a range processing stage, e.g., a matched filter processing stage 1122, which may be configured to generate information of a plurality of range bins, for example, based on the digital radar Rx signals.

In some demonstrative aspects, as shown in FIG. 11, baseband processing path 1146 may include a Doppler processing stage 1124, which may be configured to generate Doppler information, e.g., an RD map, for example, based on the information of the plurality of range bins.

In some demonstrative aspects, as shown in FIG. 11 baseband processing path 1146 may include an AoA processing stage 1126, which may be configured to generate AoA information, e.g., an AoA map, for example, based on the RD map.

In some demonstrative aspects, as shown in FIG. 11, baseband processing path 1146 may include a processing stage 1128 (Enhanced Algorithm), which may be configured to process the AoA map.

In some demonstrative aspects, as shown in FIG. 11, baseband processing path 1146 may include a target detection stage 1129, which may be configured to detect targets, for example, based on the AoA map, e.g., as described below.

In other aspects, baseband processing path 1146 may include any other additional and/or alternative processing stages.

In other aspects, imaging radar processing path 1140 may include any other additional and/or alternative processing stages.

In some demonstrative aspects, as shown in FIG. 11, baseband processing path 1146 may be configured to generate radar information 1113, for example, based on transmission of the radar transmit Tx signals, and processing of the radar Rx signals, for example, based on the radar Tx signals.

In some demonstrative aspects, as shown in FIG. 11, FuSa detector 1110 may include an input 1112, which may be configured to receive a plurality of digital outputs 1103 from the plurality of radar processing stages of imaging radar processing path 1140.

In some demonstrative aspects, as shown in FIG. 11, input 1112 may be configured to receive a digital output 1103 of a radar processing stage of the plurality of radar processing stages of imaging radar processing path 1140, e.g., as described below.

In some demonstrative aspects, FuSa detector 1110 may include a processor 1114, which may be configured to monitor the digital output 1103, e.g., as described below.

In some demonstrative aspects, FuSa detector 1110 may be configured to detect a FuSa event, for example, based on current data in the digital output 1103 and reference information corresponding to the radar processing stage, e.g., as described below.

In some demonstrative aspects, as shown in FIG. 11, FuSa detector 1110 may include an output 1116, which may be configured to provide a FuSa alert 1118, for example, to indicate detection of the FuSa event.

In some demonstrative aspects, processor 1114 may be configured to monitor a digital output 1125 of the Doppler processing stage 1124 of the imaging radar processing path 1140, e.g., as described below.

In some demonstrative aspects, processor 1114 may be configured to detect the FuSa event, for example, based on current data in the digital output 1125 of the Doppler processing stage, e.g., as described below.

In some demonstrative aspects, the current data in the digital output 1125 of the Doppler processing stage 1124 may include a current noise floor level of an RD map, e.g., as described below.

In some demonstrative aspects, FuSa detector 1110 may be configured to detect a FuSa event, for example, based on the current data in the digital output 1125 and reference information corresponding to the Doppler processing stage 1124, e.g., as described below.

In some demonstrative aspects, the reference information may include a previous noise floor level of the RD map, e.g., as described below.

In some demonstrative aspects, processor 1114 may be configured to generate the FuSa alert 1118, for example, based on a determination that a difference between the current noise floor level of the RD map and the previous noise floor level of the RD map is greater than a noise floor level threshold, e.g., as described below.

In some demonstrative aspects, processor 1114 may be configured to utilize one or more metrics (“Doppler noise metrics”), e.g., including the noise floor level of the RD map, which are based on a noise level of the Doppler processing stage 1124, for example, to detect FuSa events.

In some demonstrative aspects, processor 1114 may be configured to monitor changes in the one or more Doppler noise metrics between frames.

In some demonstrative aspects, processor 1114 may be configured to monitor changes in time, for example, in a median and/or a standard Deviation (STD) of a noise floor level of the Doppler processing stage 1124, e.g., representing a noise floor level of a virtual array.

In one example, processor 1114 may be configured to monitor the noise floor level of one or more RD bins of the RD map, which do not include detected targets. For example, in many use cases and/or scenarios, a large portion of the RD bins, e.g., about 90% of a 4D cube, may not include detected targets. For example, processor 1114 may monitor the noise floor level of the RD bins which do not include detected targets, for example, to monitor FuSa of Rx processing path 1161 and/or Tx processing path 1131, for example, with an increased accuracy, for example, within a selected virtual array map.

In some demonstrative aspects, the current noise floor level of the RD map may be monitored, for example, to provide a technical solution to ensure an overall system health of radar system 1100.

In some demonstrative aspects, processor 1114 may be configured to monitor the current noise floor level of the RD map, for example, to provide a technical solution to ensure a FuSa of Tx processing path 1131 and/or a FuSa of Rx path 1161.

In some demonstrative aspects, processor 1114 may be configured to monitor the current noise floor level of the RD map, for example, to provide a technical solution to find locations of potential noise contributors that impact FuSa of radar system 1100.

In some demonstrative aspects, processor 1114 may be configured to monitor the current noise floor level of the RD map, for example, to provide a technical solution to cover FuSa of an analog Tx-Rx path, e.g., an E2E analog Tx-Rx path, of imaging radar processing path 1140.

In one example, the analog Tx-Rx path may include a path between Tx processing path 1131 and Rx processing path 1161.

In one example, the analog Tx-Rx path may record and impact samples in the time domain. For example, these time-domain samples may be averaged across the imaging radar processing path 1140, for example, until being processed as targets, e.g., with all the rest of the samples in the frame. Accordingly, any non-correlated noise may be averaged in the frame.

In some demonstrative aspects, monitoring noise measurements per Tx processing path 1131 and/or per Rx processing path 1161 via an entire 4D cube may provide, for example, a technical solution to ensure monitoring of significant noise sources, which may impact performance of radar system 1100.

In some demonstrative aspects, processor 1114 may be configured to select not to provide a FuSa decision, e.g., by selecting not to generate FuSa alert 1118 when the radar system 1100 is determined to be safe, for example, when a difference between the current noise floor level and a previous noise floor level does not exceed the noise floor level threshold.

In some demonstrative aspects, processor 1114 may be configured to monitor the current noise floor level of the RD map, for example, to provide a technical solution to cover one or more FuSa issues of one or more analog processing blocks of imaging radar processing path 1140.

In one example, processor 1114 may be configured to monitor the current noise floor level of the RD map, for example, to provide a technical solution to cover, for example, ADC technical issues, Power Amplifier (PA) technical issues, low noise amplifier (LNA) technical issues, filter technical issues, and/or any other additional and or alternative technical issues in imaging radar processing path 1140.

In some demonstrative aspects, processor 1114 may be configured to monitor the current noise floor level of the RD map, for example, to provide a technical solution to cover one or more FuSa issues of one or more digital processing blocks of imaging radar processing path 1140.

In some demonstrative aspects, processor 1114 may be configured to monitor the current noise floor level of the RD map, for example, to provide a technical solution to cover, for example, transient faults and/or permanent faults in the one or more digital processing blocks. For example, the transient and/or permanent faults may cause severe compute faults, which may be reflected in the noise parameters.

In some demonstrative aspects, the one or more digital processing blocks may include, for example, cross correlation (XCORR) filters, digital signal processing (DSPs) blocks, and/or any other additional and or alternative digital processing blocks in imaging radar processing path 1140.

In some demonstrative aspects, processor 1114 may be configured to monitor the current noise floor level of the RD map, for example, in an RD domain, e.g., based on the current data in digital output 1125 of the Doppler processing stage 1124. For example, the current noise floor level may be extracted in the RD domain, e.g., in a relatively easy and/or reliable manner.

In other aspects, processor 1114 may be configured to determine, measure, and/or monitor, a current noise level at any other additional and/or alternative processing stage of the imaging radar processing path 1140. For example, a noise level of a processing path of a system, which is based on statistical detection, for example, a noise level of a radar processing path, e.g., imaging radar processing path 1140, may reflect safeness of the processing path of the system.

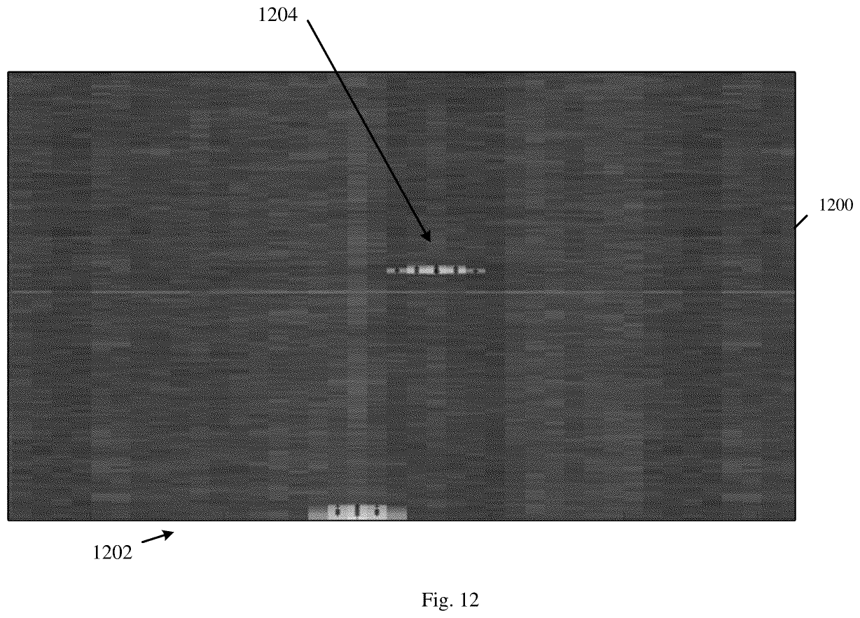

Reference is made to FIG. 12, which schematically illustrates an RD map 1202 of a frame, which may be implemented in accordance with some demonstrative aspects.

In some demonstrative aspects, processor 1114 (FIG. 11) may be configured to monitor a current noise floor level of RD map 1200.

In some demonstrative aspects, processor 1114 (FIG. 11) may be configured to identify a FuSa event, for example, based on a determination that a difference between the current noise floor level of the RD map 1202 and a previous noise floor level of the RD map of a previous frame is greater than a noise floor level threshold.

In some demonstrative aspects, an RD bin of RD map 1200 may represent a full virtual array element, e.g., including, for example, 100 samples or any other count of samples.

In some demonstrative aspects, as shown in FIG. 12, one or more RD bins 1204 may have a target and/or an energy, while other RD bins 1202 (“empty” bins), e.g., the rest of the RD bins of RD map 1200, may have about a same noise level.

In some demonstrative aspects, as shown in FIG. 12, most RD bins of RD map 1200, e.g., RD bins 1202, may not include targets. Accordingly, RD bins 1202 may represent the noise-floor level of a radar device.

In some demonstrative aspects, processor 1114 (FIG. 11) may be configured to detect increments of the noise level from frame to frame, for example, in RD bins 1202.

In one example, noise level increments of RD bins 1202 may be correlated with FuSa issues in the system. Accordingly, detecting the increments of the noise level in RD bins 1202 from frame to frame may provide a technical solution to identify a safe state or a FuSa event of a radar system, e.g., radar system 1100.

In some demonstrative aspects, processor 1114 (FIG. 11) may be configured to monitor the noise-floor level in RD bins 1202.

In one example, the radar device may be considered safe, e.g., as long as the noise level is generally constant or has relatively little change, for example, as it may indicate no FuSa issues in the radar system.

In another example, one or more bit flips and/or one or more technical issues in transients, which may not affect the noise floor level, may not affect the safety of the radar system. Accordingly, monitoring the current noise floor level of the RD map may provide a robust technical solution, for example, even in case of bit flips and/or technical issues in transients.

In some demonstrative aspects, it may be assumed that the noise is random and not coherent with a processing pipe, e.g., imaging radar processing path 1140 (FIG. 11). For example, this assumption may be true for about 99.9% of the cases.

Referring back to FIG. 11, in some demonstrative aspects, processor 1114 may be configured to monitor a digital output 1123 of the matched filter processing stage 1122 of the imaging radar processing path 1140, e.g., as described below.

In some demonstrative aspects, processor 1114 may be configured to detect a FuSa event, for example, based on current data in the digital output 1123 of the matched filter processing stage 1122, e.g., as described below.

In some demonstrative aspects, the current data in the digital output 1123 of the matched filter processing stage 1122 may include a current leakage level of a range bin, e.g., as described below.

In some demonstrative aspects, the current data in the digital output 1123 of the matched filter processing stage 1122 may include a current leakage level of a first-in-order range-bin, denoted RB[0], e.g., as described below. In other aspects, any other additional or alternative range bin may be used.

In some demonstrative aspects, processor 1114 may be configured to detect the FuSa event, for example, based on a comparison between the current data in the digital output 1123 and reference information corresponding to the matched filter processing stage 1122, e.g., as described below.

In some demonstrative aspects, the reference information corresponding to the matched filter processing stage 1122 may include a previous leakage level of the range bin, for example, the first-in-order range-bin RB[0], e.g., as described below.

In some demonstrative aspects, processor 1114 may be configured to generate the FuSa alert 1118, for example, based on a determination that a difference between the current leakage level of the range-bin and the previous leakage level of the range-bin is greater than a leakage level threshold, e.g., as described below.

In some demonstrative aspects, processor 1114 may be configured to generate the FuSa alert 1118, for example, based on a determination that a difference between the current leakage level of the first-in-order range-bin and the previous leakage level of the first-in-order range-bin RB[0] is greater than the leakage level threshold, e.g., as described below.

In one example, the current leakage level of the range bin, e.g., the first-in-order range-bin RB[0], may be based on, and/or may represent, a Tx-Rx leakage, for example, from Tx processing path 1131 to Rx processing path 1161, in a radar frame, e.g., as described below.

In some demonstrative aspects, the Tx-Rx leakage may be present, e.g., may always be present, in the first-in-order range-bin RB[0], for example, as a result of simultaneous, or substantially simultaneous, transmission and reception of radar signals.

In some demonstrative aspects, the leakage level in the first-in-order range-bin RB[0] may be monitored, for example, in a virtual array on a Doppler bin belonging to an ego speed, for example, to provide a technical solution to monitor FuSa of an analog Tx-Rx path, for example, a Tx-Rx E2E path, e.g., for a pair, e.g., each pair, of a Tx antenna and an Rx antenna.

In some demonstrative aspects, processor 1114 may be configured to monitor the leakage level in the first-in-order range-bin RB[0], for example, to detect changes, e.g., significant changes, in the leakage level. For example, a change, e.g., a significant change, in the leakage level may indicate one or more FuSa issues in the Tx-Rx path, for example, at a Tx PA, at an Rx main gain path, and/or at one or more additional or alternative elements of the Tx-Rx path.

For example, processor 1114 may be configured to identify a change, e.g., a significant change, in the leakage level in the first-in-order range-bin RB[0], for example, to identify a potential FuSa event corresponding to the Tx-Rx path.

In some demonstrative aspects, processor 1114 may be configured to monitor the leakage level in the first-in-order range-bin RB[0], for example, to provide a technical solution to ensure FuSa for an analog Tx-Rx path, e.g., an E2E analog Tx-Rx path.

For example, processor 1114 may be configured to identify a change, e.g., a significant change, in the leakage level in the first-in-order range-bin RB[0], for example, to identify a potential FuSa event corresponding to the analog Tx-Rx path.

In some demonstrative aspects, processor 1114 may be configured to monitor the leakage level in the first-in-order range-bin RB[0], for example, to provide a technical solution to ensure FuSa for one or more analog main gain components and/or one or more energy components of the analog E2E analog Tx-Rx path.

In some demonstrative aspects, processor 1114 may be configured to monitor the leakage level in the first-in-order range-bin RB[0], for example, to provide a technical solution to ensure FuSa for the one or more analog main gain and/or energy components, for example, including integrity of antenna elements, a Tx PA, an Rx LNA, an Rx Programmable Gate Array (PGA), Rx filters, and/or any other additional or alternative gain related and/or energy related components of imaging radar processing path 1140.

For example, processor 1114 may be configured to identify a change, e.g., a significant change, in the leakage level in the first-in-order range-bin RB[0], for example, to identify a potential FuSa event corresponding to the integrity of antenna elements, the Tx PA, the Rx LNA, the Rx PGA, the Rx filters, and/or any other additional or alternative gain related and/or energy related components of imaging radar processing path 1140.

In some demonstrative aspects, processor 1114 may be configured to monitor the leakage level in the first-in-order range-bin RB[0], for example, to provide a technical solution to ensure FuSa for an ADC and/or a DAC in imaging radar processing path 1140.

For example, processor 1114 may be configured to identify a change, e.g., a significant change, in the leakage level in the first-in-order range-bin RB[0], for example, to identify a potential FuSa event corresponding to the ADC and/or DAC of imaging radar processing path 1140.

In some demonstrative aspects, processor 1114 may be configured to monitor the leakage level in the first-in-order range-bin RB[0], for example, to provide a technical solution to ensure FuSa for one or more interfaces and/or logic between Tx processing path 1131 and Rx processing path 1161.

For example, processor 1114 may be configured to identify a change, e.g., a significant change, in the leakage level in the first-in-order range-bin RB[0], for example, to identify a potential FuSa event corresponding to interfaces, e.g., interfaces to RF chips, and/or logic between Tx processing path 1131 and Rx processing path 1161.

In some demonstrative aspects, processor 1114 may be configured to monitor the leakage level in the first-in-order range-bin RB[0], for example, based on the current data in the digital output 1123 of the matched filter processing stage 1122, e.g., as described above.

In other aspects, processor 1114 may be configured to determine, measure and/or monitor, the leakage level based on any other stage of the imaging radar processing path 1140.

For example, processor 1114 may be configured to determine, measure and/or monitor a self-leakage level, which may represent, and/or may be affected by, a self-impact of a Tx path, e.g., Tx processing path 1131, which may be recorded at an Rx path, e.g., Rx processing path 1161. For example, the self-leakage level may be utilized as a mechanism to ensure FuSa of the Tx path, e.g., Tx processing path 1131, for example, to ensure that the Tx path is “alive” and at a high-level of functionality.

In some demonstrative aspects, processor 1114 may be configured to determine, measure, and/r monitor the leakage level, for example, at an analog domain of imaging radar processing path 1140, or at any other stage of the digital-domain of imaging radar processing path 1140, for example, to ensure safeness of Tx processing path 1131.

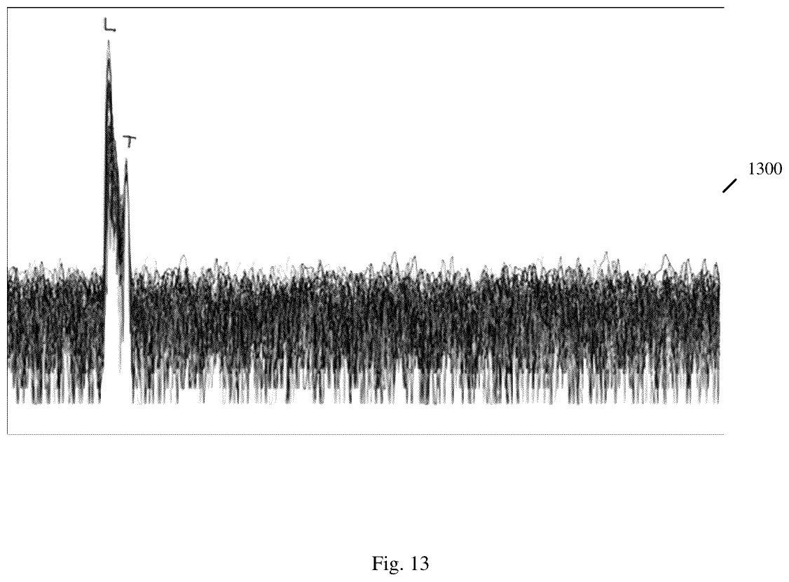

Reference is made to FIG. 13, which schematically illustrates a matched filter output 1300, which may be implemented in accordance with some demonstrative aspects. In one example, matched filter output 1300 may represent the digital output 1123 (FIG. 11) of matched filter processing stage 1122 (FIG. 11) for a particular virtual antenna element. For example, matched filter output 1300 may represent a plurality of energy values for a respective plurality of range bins corresponding to the particular virtual antenna element.

For example, as shown in FIG. 13, matched filter output 1300 may include a plurality of range bis, e.g., 300 range bins or any other count of range bins. For example, a range bin may represent a predefined range of a predefined length, 0.5 meters (m) or any other length. For example, 300 range bins with a length of 0.5 m per bin may represent a total range of 150 m from a radar device.

In some demonstrative aspects, as shown in FIG. 13, the matched filter output 1300 may be used to identify a leakage level and/or one or more strong reflections, e.g., from potential targets.

For example, as shown in FIG. 13, a leakage, denoted L, e.g., Tx-Rx leakage, may be detected, for example, in a first-in-order range-bin RB[0], e.g., based on the matched filter output 1300.

In some demonstrative aspects, as shown in FIG. 13, a potential target, denoted T, may be detected in another bin of the matched filter output 1300.

In some demonstrative aspects, the leakage L may be detected in the first-in-order range-bin RB[0], e.g., at range of 0-0.5 from the radar device. For example, the leakage L may be the strongest energy, which may be very visible, e.g., as shown in FIG. 13, and/or may be relatively stable.

In some demonstrative aspects, processor 1114 (FIG. 11) may be configured to monitor a leakage level of the leakage L corresponding to the first-in-order range-bin RB[0] of the matched filter output 1300.

In some demonstrative aspects, processor 1114 (FIG. 11) may be configured to determine a FuSa event, for example, based on a determination that a difference between the current leakage level of the leakage L, e.g., as identified in the first-in-order range-bin RB[0] of the matched filter output 1300, and a previous leakage level of the leakage L, e.g., as identified in the first-in-order range-bin RB[0] of a previous matched filter output, is greater than a leakage level threshold.

In some demonstrative aspects, processor 1114 (FIG. 11) may be configured to monitor the leakage level of the leakage L, e.g., on a frame-to-frame basis, for example, to identify a change in the leakage level of the leakage L, which may trigger detection of a FuSa event, e.g., for the analog Tx-Rx path.

Referring back to FIG. 11, in some demonstrative aspects, processor 1114 may be configured to monitor a digital output 1127 of the AoA processing stage 1126 of the imaging radar processing path 1140, e.g., as described below.

In some demonstrative aspects, processor 1114 may be configured to detect a FuSa event, for example, based on current data in the digital output 1127 of the AoA processing stage 1126, e.g., as described below.

In some demonstrative aspects, processor 1114 may be configured to detect a FuSa event based, for example, on the current data in the digital output 1127 of the AoA processing stage 1126 and reference information corresponding to the AoA processing stage 1126, e.g., as described below.

In some demonstrative aspects, the current data in the digital output 1127 of the AoA processing stage 1126 may include a current side lobe level (SLL) value of an AoA map of an RD bin, e.g., as described below.

In some demonstrative aspects, the RD bin may include a single-target RD bin including only one target, e.g., as described below.

In one example, the single-target RD bin may include a specific RD bin having a single significant target.

In some demonstrative aspects, the SLL level of the single-target RD bin may be used to detect a FuSa event, for example, as a noise floor of the single-target RD should be expected to be relatively “clean”, e.g., except for a peak corresponding to the single significant target.

In other aspects, the FuSa event may be detected based on the SLL level of any other additional or alternative RD bin.

For example, monitoring the SLL level of the single-target RD bin may provide a technical solution to achieve relatively accurate readings and/or analysis, e.g., compared to an RD bin having more than one target, which may be less effective, e.g., in some use cases.

In other aspects, the SLL level may be monitored with respect to one or more other RD bins, e.g., RD bins having more than one target, for example, in implementations of radar systems, which may have limited capabilities with respect to measuring the SLL level on RD bins.

In some demonstrative aspects, the reference information corresponding to the AoA processing stage 1126 may include, for example, a previous SLL value of the AoA map of the RD bin, e.g., as described below.

In some demonstrative aspects, processor 1114 may be configured to generate the FuSa alert 1118, for example, based on a determination that a difference between the current SLL value, e.g., of the AoA map of the RD bin, and the previous SLL value, e.g., of the AoA map of the RD bin, is greater than an SLL threshold, e.g., as described below.

In some demonstrative aspects, the current SLL value and/or the previous SLL value may include Peak SLL (PSLL) values, e.g., as described below.

In some demonstrative aspects, the current SLL value and/or the previous SLL value may include Mean SLL (MSLL) values, e.g., as described below.

In other aspects, the current SLL value and the previous SLL value may include any other SLL values.

In some demonstrative aspects, processor 1114 may be configured to monitor the SLL levels in an AoA map, for example, on a frame-to-frame basis, for example, to identify a change in the SLL level, which may trigger detection of a FuSa event.

In some demonstrative aspects, it may be advantageous to use the detected changes of the SLL levels to detect FuSa events, for example, as the SLL levels may usually have relatively good performance for an imaging radar implementation.

In one example, processor 1114 may be configured to monitor changes in the SLL levels, for example, to detect fine-tuning issues, e.g., in system coherency and/or functionality of radar imaging system 1100.

In some demonstrative aspects, processor 1114 may be configured to monitor the SLL levels, for example, to detect a degradation, e.g., a significant degradation, in the SLL of an RD bin, e.g., the single-target RD bin. For example, degradation, e.g., significant degradation, in the SLL may indicate one or more FuSa issues in an analog Tx-Rx path, e.g., in the E2E analog Tx-Rx domain.

In some demonstrative aspects, processor 1114 may be configured to monitor the SLL level in at least one particular RD bin, e.g., the single-target RD bin, for example, to provide a technical solution to detect one or more contributors for lack of coherency in the radar system 1100.

In one example, the one or more contributors for lack of coherency in radar system 1100 may include, for example, an LO distribution network, one or more element patterns of an antenna, an analog Tx-Rx path in an RF domain, timing issues of an ADC and/or a DAC in the imaging radar processing path 1140, and/or any other additional or alternative elements and/or components of radar system 1100.

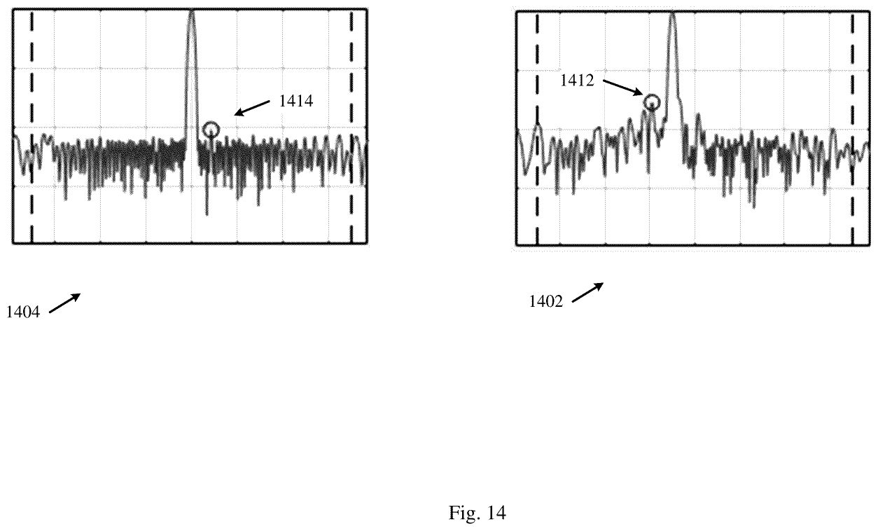

Reference is made to FIG. 14, which schematically illustrates a first AoA map 1402 and a second AoA map 1404 of an RD bin, which may be implemented in accordance with some demonstrative aspects.

In one example, first AoA map 1402 may represent an AoA map of an RD bin in a current frame, e.g., in the digital output 1127 (FIG. 11) of the AoA processing stage 1126 (FIG. 11). For example, the AoA map 1402 may represent a situation of the current frame under insertion of impairments and/or noise, e.g., which should trigger a FuSa event.

In one example, second AoA map 1404 may represent an AoA map of the RD bin of in a previous frame, e.g., in the digital output 1127 (FIG. 11) of the AoA processing stage 1126 (FIG. 11). For example, the AoA map 1404 may represent a situation of one or more previous frames of a functional system without impairments.

In one example, processor 1114 (FIG. 11) may be configured to determine a FuSa event, for example, based on a comparison between a current SLL value 1412 of the AoA map 1402, and a previous SLL value 1414 of the AoA map 1404.

In some demonstrative aspects, as shown in FIG. 14, the previous SLL value 1414 may represent an SLL level, which may be properly leveled, for example, for a functional system without impairments.

In some demonstrative aspects, as shown in FIG. 14, the SLL value of the AoA map 1402 may be degraded, for example, under insertion of impairments and/or noise.

In some demonstrative aspects, as shown in FIG. 14, SLL value 1412 may be greater than SLL value 1414, for example, as the SLL value, which may be sensitive to noise, may increase, e.g., under insertion of impairments and/or noise.

In some demonstrative aspects, processor 1114 (FIG. 11) may be configured to generate the FuSa alert 1118 (FIG. 11), for example, based on a determination that a difference between the current SLL value 1412 of the AoA map 1402 and the previous SLL value 1414 of the AoA map 1404 is greater than an SLL threshold.

In one example, the SLL threshold may be set, for example, based on system calibration, for example, to identify real time degradation in the SLL of an AoA map.

In some demonstrative aspects, the digital output 1127 (FIG. 11) of the AoA processing stage 1126 (FIG. 11) may include, for an RD bin, e.g., for each RD bin, an AoA map, e.g., a full AoA map, of a virtual element of a virtual array antenna.

In some demonstrative aspects, as shown in FIG. 14, an AoA map, e.g., AoA map 1404, may include a peak, e.g., a single peak, representing a potential target, for example, when the RD bin includes only one target. For example, as shown in FIG. 14, AoA map 1404 may include SLL noise on a side of the peak.

In some demonstrative aspects, a noise floor level of the AoA map may be sensitive to technical issues and/or impairments in an analog Tx-Rx path, and/or to faults of synchronization in an antenna array.

In some demonstrative aspects, processor 1114 (FIG. 11) may be configured to monitor changes in the SLL values of the AoA map of one or more RD bins, e.g., single-target RD bins.

In some demonstrative aspects, processor 1114 (FIG. 11) may be configured to generate the FuSa alert 1118 (FIG. 11), for example, based on a determination that a change in the SLL values of the AoA map is greater than the SLL threshold.

Referring back to FIG. 11, in some demonstrative aspects, processor 1114 may be configured to monitor a digital output 1135 of the digital Tx frontend processing stage 1134 of the imaging radar processing path 1140, e.g., as described below.

In some demonstrative aspects, processor 1114 may be configured to detect a FuSa event, for example, based on current data in the digital output 1135 of the digital Tx frontend processing stage 1134, e.g., as described below.

In some demonstrative aspects, the current data in the digital output 1135 of the digital Tx frontend processing stage 1134 may include a current Tx digital signature of a digital radar Tx signal, e.g., as described below.

In some demonstrative aspects, processor 1114 may be configured to detect the FuSa event, for example, based on the current data in the digital output 1134 of the digital Tx frontend processing stage 1134, and reference information corresponding to the digital Tx frontend processing stage 1134, e.g., as described below.

In some demonstrative aspects, the reference information corresponding to the Digital Tx frontend processing stage 1134 may include a reference Tx digital signature, e.g., as described below.

In some demonstrative aspects, processor 1114 may be configured to generate the FuSa alert 1118, for example, based on a determination that the current Tx digital signature and the reference Tx digital signature do not match, e.g., as described below.

In some demonstrative aspects, the reference information corresponding to the digital Tx frontend processing stage 1134 may be based, for example, on a predefined Tx digital signature to be applied to a digital input of the digital Tx frontend processing stage 1134, e.g., as described below.

In some demonstrative aspects, imaging radar system 1100 may include a Tx pattern generator (not shown in FIG. 11) configured to generate the predefined Tx digital signature, e.g., as described below.

In some demonstrative aspects, the Tx pattern generator may be configured to apply the predefined Tx digital signature to a digital input of the digital Tx frontend processing stage 1134, e.g., as described below.

In some demonstrative aspects, the reference Tx digital signature may include the predefined Tx digital signature.

In some demonstrative aspects, the reference Tx digital signature may include an expected Tx signature at an output of the digital Tx frontend processing stage 1134.

In some demonstrative aspects, the expected Tx signature may be based on the predefined Tx digital signature.

In some demonstrative aspects, the expected Tx signature may include an expected Tx signature at an output of the digital Tx frontend processing stage 1134, for example, when the predefined Tx digital signature is provided as an input to the digital Tx frontend processing stage 1134.

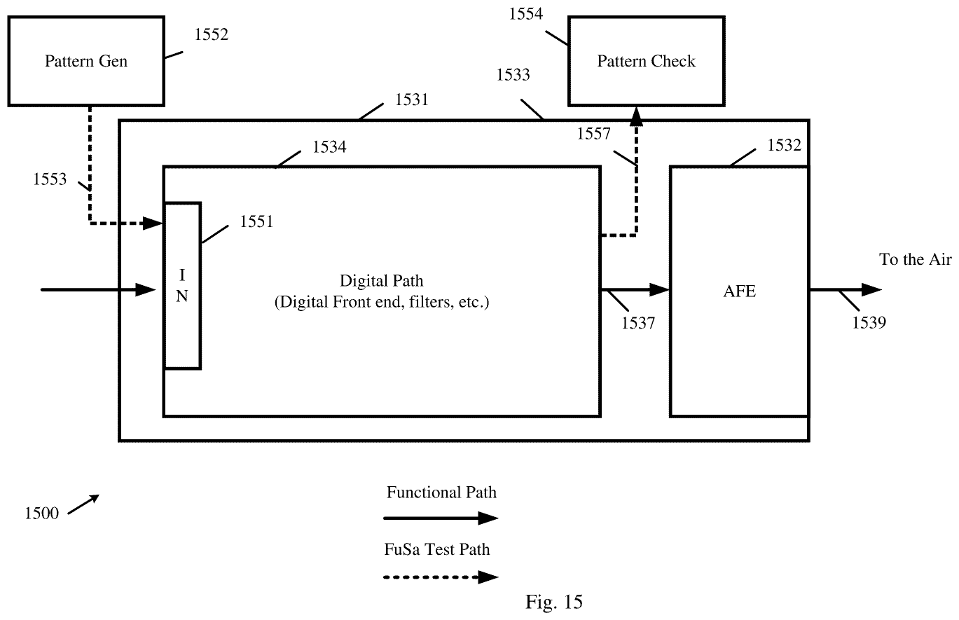

Reference is made to FIG. 15, which schematically illustrates elements of a radar processing path 1500, which may be implemented for FuSa event detection, in accordance with some demonstrative aspects. For example, radar system 1000 (FIG. 10) may include one or more elements of radar processing path 1500, and/or may perform one or more operations and/or functionalities of radar processing path 1500.

In some demonstrative aspects, as shown in FIG. 15, radar processing path 15000 may include a Tx processing path 1531. For example, Tx processing path 1131 (FIG. 11) may include one or more elements of Tx processing path 1531, and/or may perform the functionality of Tx processing path 1531.

In some demonstrative aspects, as shown in FIG. 15, Tx processing path 1531 may include a digital Tx frontend processing stage 1534, which may be configured to generate Tx digital signals 1537.

In some demonstrative aspects, the digital Tx frontend processing stage 1534 may be implemented, for example, as part of an SDR.

In some demonstrative aspects, the digital Tx frontend processing stage 1534 may include, for example, a relatively large amount of digital logic.

In some demonstrative aspects, the digital Tx frontend processing stage 1534 may be deterministic, e.g., by nature, for example, in an SDR implementation.

In some demonstrative aspects, a FuSa processor, e.g., processor 1114 (FIG. 11), may be configured to provide a technical solution to confirm FuSa of the digital logic of the digital Tx frontend processing stage 1534, e.g., as described below.

In some demonstrative aspects, as shown in FIG. 15, Tx processing path 1531 may include an analog Tx frontend processing stage 1532, which may be configured to transmit radar Tx signals 1539, for example, based on the digital Tx signals 1537.

In some demonstrative aspects, as shown in FIG. 15, radar processing path 1500 may include a pattern generator 1552, which may be configured to generate a predefined Tx digital signature 1553.

In some demonstrative aspects, pattern generator 1552 may be implemented, for example, as part of a FuSa detector, e.g., FuSa detector 1110 (FIG. 11).

In some demonstrative aspects, pattern generator 1552 may be implemented, for example, as a separate element, or as part of any other element, of a radar system, e.g., radar system 1100 (FIG. 11).

In some demonstrative aspects, as shown in FIG. 15, pattern generator 1552 may be configured to apply the predefined Tx digital signature 1553 to a digital input 1551 of the digital Tx frontend processing stage 1534.

In some demonstrative aspects, the predefined Tx digital signature 1553 may be processed by the Tx processing path 1531, for example, up to a DAC (not shown in FIG. 15) in the analog Tx frontend processing stage 1532.

In some demonstrative aspects, pattern generator 1552 may be implemented to provide a technical solution to ensure safeness of an SDR, which may process a large amount of digital data. For example, pattern generator 1552 may be implemented to provide a technical solution to provide effective protection to big digital systems, e.g., SDR, where it may be hard to fully “protect” the large amount of digital data being processed.

In some demonstrative aspects, as shown in FIG. 15, radar processing path 1500 may include a pattern checker 1554, which may be configured to monitor a current Tx digital signature 1557 of a digital radar Tx signal 1537.

In some demonstrative aspects, pattern checker 1554 may be implemented, for example, as part of a FuSa detector, e.g., FuSa detector 1110 (FIG. 11).

In some demonstrative aspects, pattern checker 1554 may be implemented, for example, as a separate element, or as part of any other element, of a radar system, e.g., radar system 1100 (FIG. 11)

In some demonstrative aspects, processor 1114 (FIG. 11) may be configured to determine a FuSa event, for example, based on a comparison between the current Tx digital signature 1557 and a reference Tx digital signature.

In some demonstrative aspects, processor 1114 (FIG. 11) may be configured to determine the FuSa event, for example, based on a determination that the current Tx digital signature 1557 and the reference Tx digital signature do not sufficiently match.

In one example, pattern checker 1554 may provide an output to processor 1114 (FIG. 11), for example, to indicate whether or not the current Tx digital signature 1557 and the reference Tx digital signature sufficiently match.

In some demonstrative aspects, the reference Tx digital signature may include the predefined Tx digital signature 1553.

In some demonstrative aspects, the reference Tx digital signature may include an expected Tx signature at an output of the digital Tx frontend processing stage 1534.

In some demonstrative aspects, the expected Tx signature may be based on the predefined Tx digital signature 1553.

In some demonstrative aspects, the expected Tx signature may include the predefined Tx digital signature 1553, for example, processing by the digital Tx frontend processing stage 1534.

In some demonstrative aspects, processor 1114 (FIG. 11) may be configured to generate the FuSa alert 1118 (FIG. 11), for example, based on a comparison between the current Tx digital signature and the reference Tx digital signature, for example, to provide a technical solution to support FuSa coverage, e.g., E2E coverage, for digital Tx path 1534, e.g., an entirety of digital Tx path 1534.

In some demonstrative aspects, as shown in FIG. 15, pattern checker 1554 may be implemented to monitor the current Tx digital signature 1557 at an analog boundary between the digital Tx frontend processing stage 1534 and the analog Tx frontend processing stage 1532, for example, to provide a technical solution to support a verification that the current Tx digital signature 1557 of the digital radar Tx signal 1537 is as expected, e.g., based on the predefined Tx digital signature 1553.

In some demonstrative aspects, pattern checker 1554 may be implemented to monitor the current Tx digital signature 1557, for example, just before the digital radar Tx signal 1537 goes into the analog Tx frontend processing stage 1532, for example, to provide a technical solution to utilize the deterministic nature of the digital Tx frontend processing stage 1534 in order to monitor and/or detect digital transient faults at the digital Tx frontend processing stage 1534, which may be, by nature, very hard to capture.

In some demonstrative aspects, pattern checker 1534 may be configured to verify the current Tx digital signature 1557 of the digital radar Tx signal 1537, for example, based on the pattern provided by pattern generator 1552, e.g., as described above.

In some demonstrative aspects, pattern checker 1534 may be configured to verify the Tx signal 1537 is as expected, for example, based on the current data, e.g., of a current radar frame, in the digital output 1135 of the digital Tx frontend processing stage 1134.

For example, the digital Tx frontend processing stage 1134 may be substantially entirely digital and, accordingly, data in the digital Tx frontend processing stage 1134 may be known in advance, e.g., in an SDR radar.

For example, pattern checker 1534 may check a current frame on a boundary of the analog Tx frontend processing stage 1532, for example, using the known data in the digital Tx frontend processing stage 1134, e.g., even without debugging the predefined Tx digital signature 1553.

Referring back to FIG. 11, in some demonstrative aspects, processor 1114 may be configured to monitor a digital output 1165 of the digital Rx frontend processing stage 1164 of the imaging radar processing path 1140, e.g., as described below.

In some demonstrative aspects, processor 1114 may be configured to detect a FuSa event, for example, based on current data in the digital output 1165 of the digital Rx frontend processing stage 1164, e.g., as described below.

In some demonstrative aspects, the current data in the digital output 1165 of the digital Rx frontend processing stage 1164 may include a current Rx digital signature of a digital radar Rx signal, e.g., as described below.

In some demonstrative aspects, processor 1114 may be configured to detect the FuSa event, for example, based on the current data in the digital output 1165 of the digital Rx frontend processing stage 1164 and reference information corresponding to the digital Rx frontend processing stage 1164, e.g., as described below.

In some demonstrative aspects, the reference information corresponding to the digital Rx frontend processing stage 1164 may include a reference Rx digital signature, e.g., as described below.

In some demonstrative aspects, processor 1114 may be configured to generate the FuSa alert 1118, for example, based on a determination that the current Rx digital signature and the reference Rx digital signature do not match, e.g., as described below.

In some demonstrative aspects, the reference information corresponding to the digital Rx frontend processing stage 1164 may be based, for example, on a predefined Rx digital signature to be applied to a digital input of the digital Rx frontend processing stage 1164, e.g., as described below.

In some demonstrative aspects, imaging radar system 1100 may include an Rx pattern generator (not shown in FIG. 11) configured to generate the predefined Rx digital signature, e.g., as described below.

In some demonstrative aspects, the Rx pattern generator may be configured to apply the predefined Rx digital signature to the digital input of the digital Rx frontend processing stage 1164, e.g., as described below.

In some demonstrative aspects, the reference Rx digital signature may include the predefined Rx digital signature.

In some demonstrative aspects, the reference Rx digital signature may include an expected Rx signature at an output of the digital Rx frontend processing stage 1164.

In some demonstrative aspects, the expected Rx signature may include an expected Rx signature at an output of the digital Rx frontend processing stage 1164, for example, when the predefined Rx digital signature is provided as an input to the digital Rx frontend processing stage 1164.

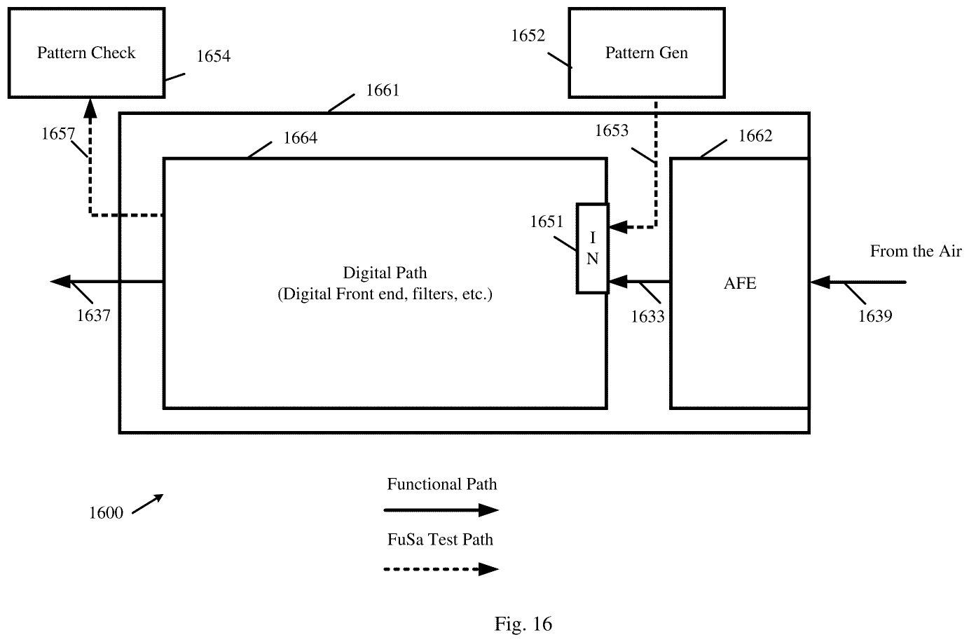

Reference is made to FIG. 16, which schematically illustrates elements of a radar processing path 1600, which may be implemented for FuSa event detection, in accordance with some demonstrative aspects. For example, radar system 1000 (FIG. 10) may include one or more elements of radar processing path 1600, and/or may perform one or more operations and/or functionalities of radar processing path 1600.

In some demonstrative aspects, as shown in FIG. 16, radar processing path 1600 may include an Rx processing path 1661. For example, Rx processing path 1161 (FIG. 11) may include one or more elements of Rx processing path 1661, and/or may perform the functionality of Rx processing path 1661.

In some demonstrative aspects, as shown in FIG. 16, Rx processing path 1661 may include an analog Rx frontend processing stage 1662, which may be configured to receive radar Rx signals 1639, for example, based on radar Tx signals, e.g., from Tx processing path 1531 (FIG. 15).

In some demonstrative aspects, as shown in FIG. 16, analog Rx frontend processing stage 1662 may be configured to provide digital radar Rx signals 1633, for example, based on the radar Rx signals 1639.

In some demonstrative aspects, as shown in FIG. 16, Rx processing path 1661 may include a digital Rx frontend processing stage 1664, which may be configured to generate Rx digital signals 1637, for example, based on the digital radar Rx signals 1633.

In some demonstrative aspects, digital Rx frontend processing stage 1664 may be implemented, for example, as part of an SDR.

In some demonstrative aspects, digital Rx frontend processing stage 1664 may be deterministic, e.g., by nature, for example, in an SDR implementation. In some demonstrative aspects, a FuSa processor, e.g., processor 1114 (FIG. 11), may be configured to provide a technical solution to confirm FuSa of the digital logic of the digital Rx frontend processing stage 1664, e.g., as described below.

In some demonstrative aspects, as shown in FIG. 16, radar processing path 1600 may include a pattern generator 1652, which may be configured to generate a predefined Rx digital signature 1653.

In some demonstrative aspects, pattern generator 1652 may be implemented, for example, as part of a FuSa detector, e.g., FuSa detector 1110 (FIG. 11).

In some demonstrative aspects, pattern generator 1652 may be implemented, for example, as a separate element, or as part of any other element, of a radar system, e.g., radar system 1100 (FIG. 11).

In some demonstrative aspects, as shown in FIG. 16, pattern generator 1652 may be configured to apply the predefined Rx digital signature 1653 to a digital radar Rx signal 1633 in a digital input 1651 of the digital Rx frontend processing stage 1664.

In some demonstrative aspects, the predefined Rx digital signature 1653 may be processed by the digital Rx frontend processing stage 1664.

In some demonstrative aspects, as shown in FIG. 16, radar processing path 1600 may include a pattern checker 1654, which may be configured to monitor a current Rx digital signature 1657 in the Rx digital signal 1637.

In some demonstrative aspects, pattern checker 1654 may be implemented, for example, as part of a FuSa detector, e.g., FuSa detector 1110 (FIG. 11).

In some demonstrative aspects, pattern checker 1654 may be implemented, for example, as a separate element, or as part of any other element, of a radar system, e.g., radar system 1100 (FIG. 11).

In some demonstrative aspects, processor 1114 (FIG. 11) may be configured to determine a FuSa event, for example, based on a comparison between the current Rx digital signature 1657 of the digital radar Rx signal 1633 and a reference Rx digital signature.

In some demonstrative aspects, processor 1114 (FIG. 11) may be configured to determine the FuSa event, for example, based on a determination that the current Rx digital signature 1657 and the reference Rx digital signature do not sufficiently match.

In some demonstrative aspects, pattern checker 1654 may provide an output to processor 1114 (FIG. 1), for example, to indicate whether or not the current Rx digital signature 1657 and the reference Rx digital signature sufficiently match.

In some demonstrative aspects, the reference Rx digital signature may include the predefined Rx digital signature 1653.

In some demonstrative aspects, the reference Rx digital signature may include an expected Rx signature at an output of the digital Rx frontend processing stage 1634.

In some demonstrative aspects, the expected Rx signature may be based on the predefined Rx digital signature 1653.

In some demonstrative aspects, the expected Rx signature may include the predefined Rx digital signature 1653 processing by the digital Rx frontend processing stage 1634.

In some demonstrative aspects, processor 1114 (FIG. 11) may be configured to generate the FuSa alert 1118 (FIG. 11), for example, based on a comparison between the current Rx digital signature and the reference Rx digital signature, for example, to provide a technical solution to support FuSa coverage, e.g., E2E coverage, for digital Rx path 1634, e.g., an entirety of digital Rx path 1634.

In some demonstrative aspects, as shown in FIG. 16, processor 1114 (FIG. 11) may be configured to provide a technical solution to provide FuSa protection on interfaces between RF chips, e.g., including Rx processing path 1661, and a main processing unit, e.g., baseband processing path 1146 (FIG. 11).

In some demonstrative aspects, as shown in FIG. 16, pattern generator 1652 may be implemented to provide the predefined Rx digital signature 1653, for example, on an analog boundary between the analog Rx frontend processing stage 1662 and the digital Rx frontend processing stage 1664.

In some demonstrative aspects, pattern generator 1652 may be configured to add the predefined Rx digital signature 1653, for example, as a “piggy tail”, to Rx digital signal 1633, which may be checked later by pattern checker 1654.

In some demonstrative aspects, pattern generator 1652 may be configured to apply the predefined Rx digital signature 1653 to an output of an ADC (not shown in FIG. 16), e.g., in analog Rx frontend processing stage 1662.

In some demonstrative aspects, pattern generator 1652 may be implemented to provide a technical solution to ensure safeness of an SDR, which may process a large amount of digital data. For example, pattern generator 1652 may be implemented to provide a technical solution to provide effective protection to big digital systems, e.g., SDR, where it may be hard to fully “protect” the large amount of digital data being processed.

In some demonstrative aspects, pattern checker 1654 may be implemented to determine whether the current Rx digital signature 1657 in the digital radar Rx signal 1637 matches the predefined Rx digital signature 1653, for example, just before digital radar Rx signal 1637 goes into a first processing block of a baseband processing path, e.g., baseband processing path 1146 (FIG. 11).

For example, pattern checker 1654 may be implemented to check whether the current Rx digital signature 1657 of a digital radar Rx signal 1637 matches the predefined Rx digital signature 1653, for example, between output of digital Rx frontend processing stage 1664 and an input of a matched filter processing stage, e.g., the matched filter processing stage 1122 (FIG. 11).

In some demonstrative aspects, processor 1114 (FIG. 11) may be configured to generate the FuSa alert 1118 (FIG. 11), for example, based on a comparison between the current Rx digital signature 1657 and the reference Rx digital signature, for example, to provide a technical solution to support FuSa coverage, e.g., E2E coverage, for an entire data interface and protocol of radar system 1600.

Referring back to FIG. 11, in some demonstrative aspects, processor 1114 may be configured to monitor a digital output 1103 of a radar processing stage, e.g., of the imaging radar processing path 1140, which may include a Tx frontend digital output 1133, e.g., as described below.

In some demonstrative aspects, the Tx frontend digital output 1133 may be based, for example, on an output of an analog Tx frontend processing stage 1132 of the imaging radar processing path 1140, e.g., as described below.

In some demonstrative aspects, processor 1114 may be configured to detect a FuSa event, for example, based on current data in the Tx frontend digital output 1133, e.g., as described below.

In some demonstrative aspects, the Tx frontend digital output 1133 may include, for example, a current Tx power level of a current analog radar Tx signal, e.g., as described below.

In some demonstrative aspects, processor 1114 may be configured to detect the FuSa event, for example, based on the current data in the Tx frontend digital output 1133 of the digital Tx frontend processing stage 1134, and reference information corresponding to the Tx frontend digital output 1133, e.g., as described below.

In some demonstrative aspects, the reference information corresponding to the analog Tx frontend processing stage 1132 may include a previous Tx power level of a previous analog radar Tx signal, e.g., as described below.

In some demonstrative aspects, processor 1114 may be configured to generate the FuSa alert 1118, for example, based on a determination that a difference between the current Tx power level and the previous Tx power level is greater than a Tx power level threshold, e.g., as described below.

In some demonstrative aspects, the Tx frontend digital output 1133 may include an output of a Tx ADC (not shown in FIG. 11), e.g., as described below.

In some demonstrative aspects, the output of the Tx ADC may be based, for example, on the current analog Tx radar signal, e.g., as described below.

In one example, the Tx ADC may be utilized, for example, to record an analog condition of the analog Tx frontend processing stage 1132, for example, during a frame.

For example, processor 1114 may be configured to detect one or more FuSa issues of a PA in the analog Tx frontend processing stage 1132. For example, the PA may include an inductance analog circuit, which may translate its power to a DC value.

For example, the DC value may be recorded and monitored, e.g., during the frame, e.g., by processor 1114.

In one example, processor 1114 may be configured to generate the FuSa alert 1118, e.g., to raise an error, for example, based on a detected deviation in the DC value.

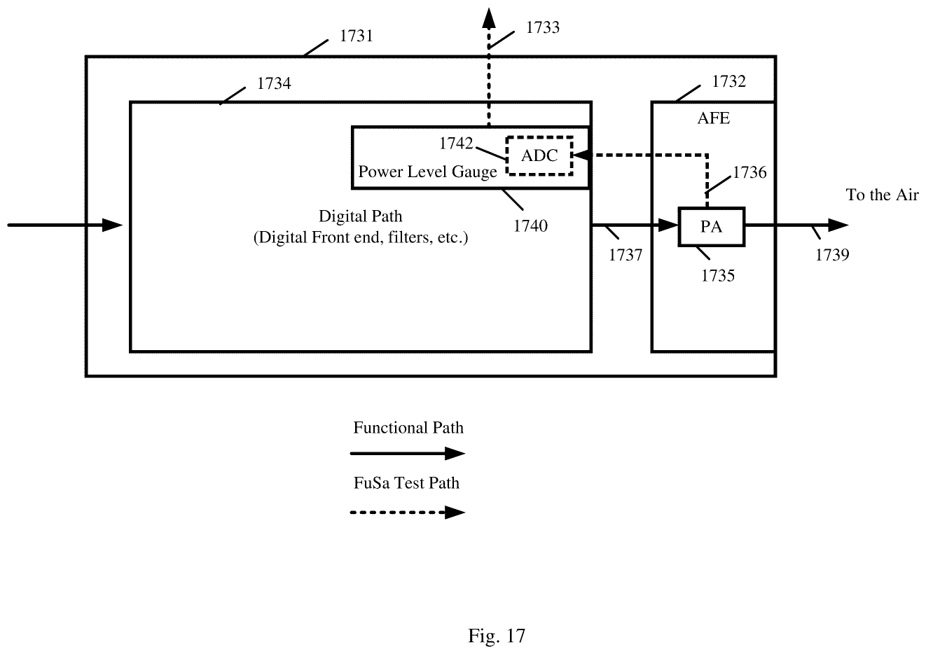

Reference is made to FIG. 17, which schematically illustrates elements of a Tx processing path 1731, which may be implemented for FuSa event detection, in accordance with some demonstrative aspects. For example, radar system 1000 (FIG. 10) may include one or more elements of Tx processing path 1731, and/or may perform the functionality of Tx processing path 1731.

In some demonstrative aspects, as shown in FIG. 17, Tx processing path 1731 may include a digital Tx frontend processing stage 1734, which may be configured to generate Tx digital signals 1737.

In some demonstrative aspects, as shown in FIG. 17, Tx processing path 1731 may include an analog Tx frontend processing stage 1732, which may be configured to transmit radar Tx signals 1739, for example, based on the digital Tx signals 1737.

In some demonstrative aspects, as shown in FIG. 17, analog Tx frontend processing stage 1732 may include a PA 1735, which may be configured to amplify a power level of the radar Tx signals 1737 to provide radar Tx signals 1739.

In some demonstrative aspects, processor 1114 (FIG. 11) may be configured to detect a FuSa event, for example, based on a current Tx power level of a current analog radar Tx signal 1739 and a previous Tx power level of a previous analog radar Tx signal 1739.

In some demonstrative aspects, processor 1114 (FIG. 11) may be configured to generate the FuSa alert 1118 (FIG. 11), for example, based on a determination that a difference between the current Tx power level and the previous Tx power level is greater than a Tx power level threshold, e.g., as described below.

In some demonstrative aspects, as shown in FIG. 17, digital Tx frontend processing stage 1734 may be configured to provide a Tx frontend digital output 1733, for example, including the current Tx power level of the current analog radar Tx signal 1739.

In some demonstrative aspects, digital Tx frontend processing stage 1734 may be configured to generate the Tx frontend digital output 1733, for example, based on an output 1736 of PA 1735.

In some demonstrative aspects, as shown in FIG. 17, digital Tx frontend processing stage 1734 may include a power level gauge 1740, which may be configured to measure the current Tx power level of the current analog radar Tx signal 1739.

In some demonstrative aspects, digital Tx frontend processing stage 1734 may include a Tx ADC 1742 to convert an analog output 1736 of PA 1735 into a digital signal, which may be used by power level gauge 1740 to determine the current Tx power level of the current analog radar Tx signal 1739.

In one example, a PA, e.g., PA 1735, may have a relatively high, e.g., a highest, stress level in Tx processing path 1731, for example, compared to other components in Tx processing path 1731.

In some demonstrative aspects, processor 1114 (FIG. 11) may be configured to detect a FuSa event, for example, by monitoring the current Tx power level of the current analog radar Tx signal 1739, for example, based on a feedback from PA 1735, e.g., output 1736, which may be fed into Tx ADC 1742.

In some demonstrative aspects, processor 1114 (FIG. 11) may be configured to monitor the current Tx power level of the current analog radar Tx signal 1739, for example, to provide a technical solution to confirm that there are no power drops, shortages, and/or glitches, for example, in output energy of analog Tx frontend processing stage 1732.

Referring back to FIG. 11, in some demonstrative aspects, processor 1114 may be configured to monitor a digital output 1103 of a radar processing stage, e.g., of the imaging radar processing path 1140, which may include an Rx frontend digital output 1163, e.g., as described below.

In some demonstrative aspects, the Rx frontend digital output 1163 may be based, for example, on an output of the analog Rx frontend processing stage 1162 of the imaging radar processing path 1140, e.g., as described below.

In some demonstrative aspects, processor 1114 may be configured to detect a FuSa event, for example, based on current data in the Rx frontend digital output 1163, e.g., as described below.

In some demonstrative aspects, the Rx frontend digital output 1163 may include, for example, a current Rx power level of a current analog radar Rx signal, e.g., as described below.

In some demonstrative aspects, processor 1114 may be configured to detect the FuSa event, for example, based on the current data in the digital output 1163 of the analog Rx frontend processing stage 1162, and reference information corresponding to the analog Rx frontend processing stage 1162, e.g., as described below.

In some demonstrative aspects, the reference information corresponding to the analog Rx frontend processing stage 1162 may include a previous Rx power level of a previous analog radar Rx signal, e.g., as described below.

In some demonstrative aspects, processor 1114 may be configured to generate the FuSa alert 1118, for example, based on a determination that a difference between the current Rx power level and the previous Rx power level is greater than a Rx power level threshold, e.g., as described below.

In some demonstrative aspects, the Rx frontend digital output 1163 may include an output of an Rx ADC (not shown in FIG. 11), e.g., as described below.

In some demonstrative aspects, the output of the Rx ADC may be based, for example, on the current analog Rx radar signal, e.g., as described below.

In some demonstrative aspects, processor 1114 may be configured to monitor the output of the Rx ADC, for example, to provide a technical solution to measure signal characteristics of the current analog Rx radar signal.

In one example, the current analog Rx radar signal may have known expected signal characteristics, e.g., a form, a gain, a DC bias, and/or the like.

In some demonstrative aspects, processor 1114 may be configured to monitor the signal characteristics of the current analog Rx radar signal, e.g., substantially accurately, and to generate the FuSa alert 1118, for example, based on detection of a significant deviation between the known expected signal characteristics and the current signal characteristics of the of the current analog Rx radar signal.

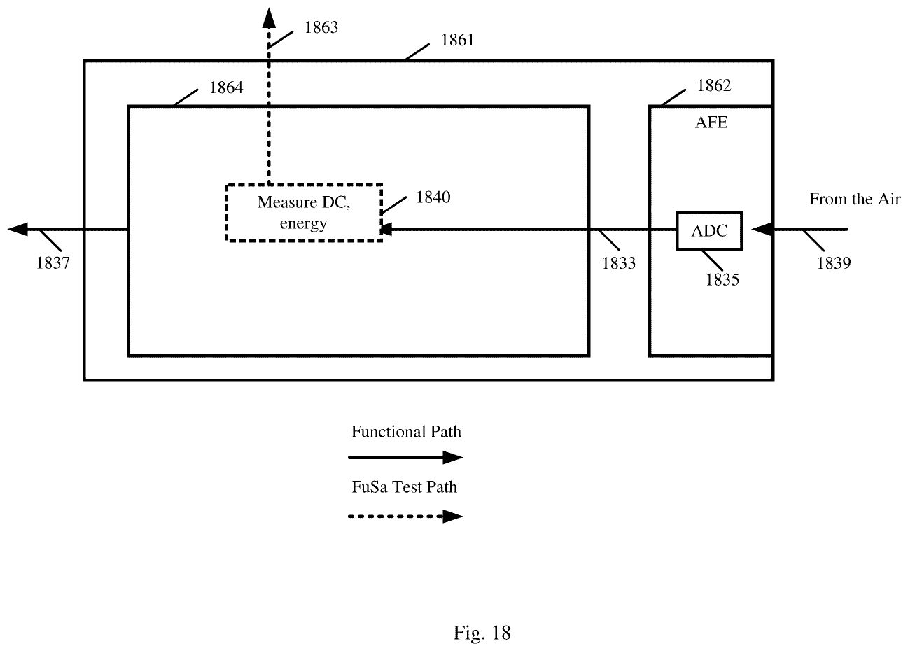

Reference is made to FIG. 18, which schematically illustrates elements of an Rx processing path 1861, which may be implemented for FuSa event detection, in accordance with some demonstrative aspects. For example, radar system 1000 (FIG. 10)) may include one or more elements of Rx processing path 1861, and/or may perform the functionality of Rx processing path 1861.

In some demonstrative aspects, as shown in FIG. 18, Rx processing path 1861 may include an analog Rx frontend processing stage 1862, which may be configured to receive radar Rx signals 1839, for example, based on radar Tx signals, e.g., from Tx processing path 1731 (FIG. 17).

In some demonstrative aspects, as shown in FIG. 18, analog Rx frontend processing stage 1862 may be configured to provide digital radar Rx signals 1833, for example, based on the radar Rx signals 1839.

In some demonstrative aspects, as shown in FIG. 18, Rx processing path 1861 may include a digital Rx frontend processing stage 1864, which may be configured to generate Rx digital frontend signals 1837, for example, based on the digital radar Rx signals 1833.

In some demonstrative aspects, as shown in FIG. 18, the analog Rx frontend processing stage 1862 may include an Rx ADC 1835, which may be configured to convert the radar Rx signals 1839 into the digital Rx signals 1833.

In some demonstrative aspects, an output of the Rx ADC 1835 may be based, for example, on a current analog Rx radar signal 1839, e.g., as described below.

In some demonstrative aspects, as shown in FIG. 18, digital Rx frontend processing stage 1864 may include an Rx power level gauge 1840, which may be configured to measure a current Rx power level of the current analog radar Rx signal 1839.

In some demonstrative aspects, processor 1114 (FIG. 11) may be configured to generate the FuSa alert 1118 (FIG. 11), for example, based on a determination that a difference between the current Rx power level of the current analog radar Rx signal 1839 and a previous Rx power level of a previous analog radar Rx signal 1839 is greater than an Rx power level threshold.

In some demonstrative aspects, as shown in FIG. 18, power level gauge 1840 may be configured to provide an Rx frontend digital output 1863, for example, to indicate the current Rx power level of the current analog radar Rx signal 1839.

In some demonstrative aspects, the Rx frontend digital output 1863 may be based, for example, on the output of the Rx ADC 1835.

In some demonstrative aspects, Rx power level gauge 1840 may be configured to monitor, ADC DC levels and/or energy levels of the current analog radar Rx signal 1839, e.g., at the output of the Rx ADC 1835.

In one example, in some implementations, e.g., an SDR implementation, a Tx-Rx leakage may be a dominant energy contributor, e.g., where BB signals may be captured, and/or a Root mean Square (RMS) level, e.g., in the time domain, may be predictable.

For example, a deviation, e.g., any deviation, from the leakage level and/or the RMS level, e.g., on a frame to frame basis, may indicate faults in an analog Tx-Rx path, e.g., the analog E2E Tx-Rx path.

In one example, Rx power level gauge 1840 may be configured to measure a DC power level, e.g., an average DC power level (AVG(x)), an RMS, an STD, a gain, e.g., abs(x)², and/or the like, on an input signal from the output of the Rx ADC 1835.

In some demonstrative aspects, the DC power level may be monitored to provide a technical solution for FuSa coverage of many possible analog faults in the Rx ADC 1835, e.g., including a stuck bit, coupling issues, Rx path gain issues, and/or the like.

In one example, processor 1114 (FIG. 11) may be configured to monitor the current Rx power level of the current analog radar Rx signal 1839, for example, based on Rx frontend digital output 1863, for example, to detect faults for a Low Noise Amplifier (LNA), shorts, RF mismatches, amplifiers in Rx processing path 1861.

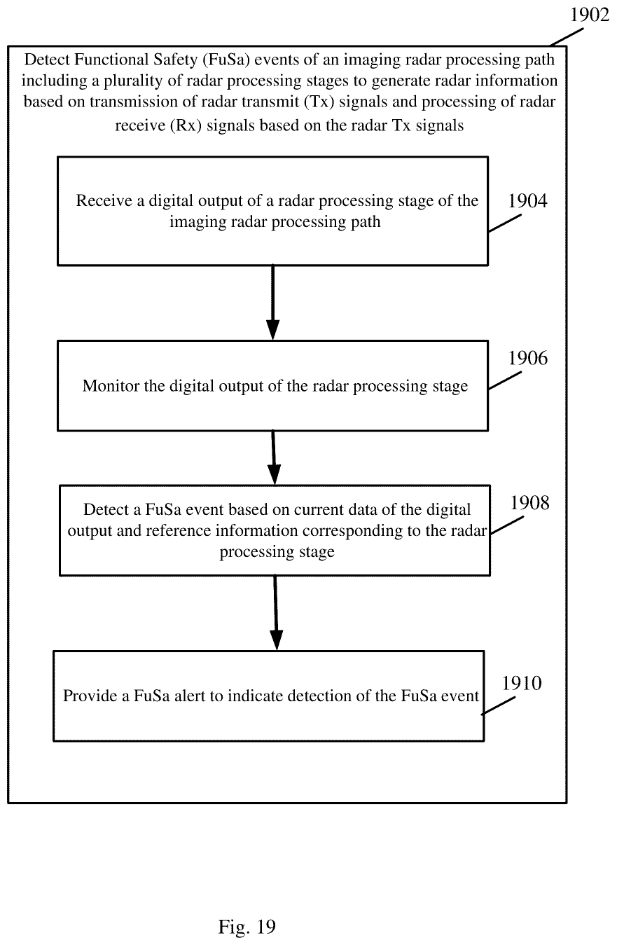

Reference is made to FIG. 19, which schematically illustrates a method of detecting FuSa events, in accordance with some demonstrative aspects. For example, one or more of the operations of the method of FIG. 19 may be performed by a radar system, e.g., radar system 900 (FIG. 9), radar system 1000 (FIG. 10), and/or radar system 1100 (FIG. 11); a radar device, e.g., radar device 800 (FIG. 8; a FuSa detector, e.g., FuSa detector 1010 (FIG. 10) and/or FuSa detector 1110 (FIG. 11); and/or a processor, e.g., processor 1014 (FIG. 10), and/or processor 1114 (FIG. 11).

As indicated at block 1902, the method may include detecting FuSa events of an imaging radar processing path including a plurality of radar processing stages to generate radar information based on transmission of radar Tx signals and processing of radar Rx signals based on the radar Tx signals, e.g., as described above.

As indicated at block 1904, detecting the FuSa events may include receiving a digital output of a radar processing stage of the imaging radar processing path. For example, processor 1014 (FIG. 10) may receive, e.g., via input 1012 (FIG. 10), the digital output 1036 (FIG. 10) of the radar processing stage 1034 (FIG. 10) of the imaging radar processing path 1040 (FIG. 10), e.g., as described above.

As indicated at block 1906, detecting the FuSa events may include monitoring the digital output of the radar processing stage. For example, processor 1014 (FIG. 10) may monitor the digital output 1036 (FIG. 10), e.g., as described above.

As indicated at block 1908, detecting the FuSa events may include detecting a FuSa event based on current data of the digital output of the radar processing stage and reference information corresponding to the radar processing stage. For example, processor 1014 (FIG. 10) may detect the FuSa events based on the current data of the digital output 1036 (FIG. 10), and the reference information corresponding to the radar processing stage 1034 (FIG. 10), e.g., as described above.

As indicated at block 1910, detecting the FuSa events may include providing a FuSa alert to indicate detection of the FuSa event. For example, processor 1014 (FIG. 10) may provide the FuSa alert 1018 (FIG. 10), e.g., via output 1016 (FIG. 10), for example, to indicate the detection of the FuSa event, e.g., as described above.

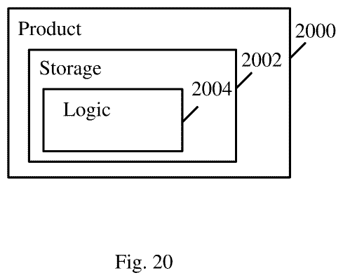

Reference is made to FIG. 20, which schematically illustrates a product of manufacture 2000, in accordance with some demonstrative aspects. Product 2000 may include one or more tangible computer-readable (“machine-readable”) non-transitory storage media 2002, which may include computer-executable instructions, e.g., implemented by logic 2004, operable to, when executed by at least one computer processor, enable the at least one computer processor to implement one or more operations and/or functionalities described with reference to any of the FIGS. 1-19, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 2000 and/or machine-readable storage media 2002 may include one or more types of computer-readable storage media capable of storing data, including volatile memory, non-volatile memory, removable or non-removable memory, erasable or non-erasable memory, writeable or re-writeable memory, and the like. For example, machine-readable storage media 2002 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 2004 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 2004 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising a Functional Safety (FuSa) detector configured to detect FuSa events of an imaging radar processing path comprising a plurality of radar processing stages to generate radar information based on transmission of radar transmit (Tx) signals and processing of radar receive (Rx) signals based on the radar Tx signals, the FuSa detector comprising an input to receive a digital output of a radar processing stage of the imaging radar processing path; a processor configured to monitor the digital output, and to detect a FuSa event based on current data of the digital output and reference information corresponding to the radar processing stage; and an output to provide a FuSa alert to indicate detection of the FuSa event.

Example 2 includes the subject matter of Example 1, and optionally, wherein the reference information corresponding to the radar processing stage represents expected data in the digital output of the radar processing stage when no FuSa event is to be detected.

Example 3 includes the subject matter of Example 1 or 2, and optionally, wherein the reference information corresponding to the radar processing stage is based on previous data in the digital output.

Example 4 includes the subject matter of Example 3, and optionally, wherein the previous data of the digital output comprises a previous value of a predefined parameter in the digital output.

Example 5 includes the subject matter of Example 4, and optionally, wherein the processor is configured to identify a current value of the predefined parameter in the digital output, and to detect the FuSa event based on a comparison between the current value of the predefined parameter and the previous value of the predefined parameter.

Example 6 includes the subject matter of Example 5, and optionally, wherein the processor is configured to detect the FuSa event based on a difference between the current value of the predefined parameter and the previous value of the predefined parameter.

Example 7 includes the subject matter of Example 6, and optionally, wherein the processor is configured to generate the FuSa alert based on a determination that the difference between the current value of the predefined parameter and the previous value of the predefined parameter is greater than a difference threshold.

Example 8 includes the subject matter of Example 6 or 7, and optionally, wherein the processor is configured to select not to generate the FuSa alert based on a determination that the difference between the current value of the predefined parameter and the previous value of the predefined parameter does not exceed a difference threshold.

Example 9 includes the subject matter of any one of Examples 1-8, and optionally, wherein the reference information comprises a reference digital signature.

Example 10 includes the subject matter of Example 9, and optionally, wherein the processor is configured to identify a current digital signature in the current data, and to detect the FuSa event based on a comparison between the current digital signature and the reference digital signature.

Example 11 includes the subject matter of Example 10, and optionally, wherein the processor is configured to generate the FuSa alert based on a determination that the current digital signature and the reference digital signature do not match.

Example 12 includes the subject matter of Example 10 or 11, and optionally, wherein the processor is configured to select not to generate the FuSa alert based on a determination that the current digital signature matches the reference digital signature.

Example 13 includes the subject matter of any one of Examples 9-12, and optionally, wherein the reference digital signature is based on a predefined digital signature to be applied to a digital input of the radar processing stage.

Example 14 includes the subject matter of Example 13, and optionally, comprising a pattern generator configured to generate the predefined digital signature and to apply the predefined digital signature to the digital input of the radar processing stage.

Example 15 includes the subject matter of any one of Examples 1-14, and optionally, wherein the digital output of the radar processing stage comprises an output of an Analog to Digital Converter (ADC) based on analog radar signals processed by an analog radar processing stage of the imaging radar processing path.

Example 16 includes the subject matter of any one of Examples 1-15, and optionally, wherein the processor is configured to monitor a digital output of a Doppler processing stage of the imaging radar processing path, and to detect the FuSa event based on current data in the digital output of the Doppler processing stage.

Example 17 includes the subject matter of Example 16, and optionally, wherein the current data in the digital output of the Doppler processing stage comprises a current noise floor level of a Range-Doppler (RD) map, wherein the reference information comprises a previous noise floor level of the RD map.

Example 18 includes the subject matter of Example 17, and optionally, wherein the processor is configured to generate the FuSa alert based on a determination that a difference between the current noise floor level of the RD map and the previous noise floor level of the RD map is greater than a noise floor level threshold.

Example 19 includes the subject matter of any one of Examples 1-18, and optionally, wherein the processor is configured to monitor a digital output of a matched filter processing stage of the imaging radar processing path, and to detect the FuSa event based on current data in the digital output of the matched filter processing stage.

Example 20 includes the subject matter of Example 19, and optionally, wherein the current data in the digital output of the matched filter processing stage comprises a current leakage level of a first-in-order range-bin, wherein the reference information comprises a previous leakage level of the first-in-order range-bin.

Example 21 includes the subject matter of Example 20, and optionally, wherein the processor is configured to generate the FuSa alert based on a determination that a difference between the current leakage level of the first-in-order range-bin and the previous leakage level of the first-in-order range-bin is greater than a leakage level threshold.

Example 22 includes the subject matter of any one of Examples 1-21, and optionally, wherein the processor is configured to monitor a digital output of an Angle of Arrival (AoA) processing stage of the imaging radar processing path, and to detect the FuSa event based on current data in the digital output of the AoA processing stage.

Example 23 includes the subject matter of Example 22, and optionally, wherein the current data in the digital output of the AoA processing stage comprises a current side lobe level (SLL) value of an AoA map of a Range-Doppler (RD) bin, wherein the reference information comprises a previous SLL value of the AoA map of the RD bin.

Example 24 includes the subject matter of Example 23, and optionally, wherein the processor is configured to generate the FuSa alert based on a determination that a difference between the current SLL value of the AoA map of the RD bin and the previous SLL value of the AoA map of the RD bin is greater than an SLL threshold.

Example 25 includes the subject matter of Example 23 or 24, and optionally, wherein the current SLL value and the previous SLL value comprise Peak SLL (PSLL) values or Mean SLL (MSLL) values.

Example 26 includes the subject matter of any one of Examples 23-25, and optionally, wherein the RD bin comprises a single-target RD bin comprising only one target.

Example 27 includes the subject matter of any one of Examples 1-26, and optionally, wherein the processor is configured to monitor a digital output of a digital Tx frontend processing stage of the imaging radar processing path, and to detect the FuSa event based on current data in the digital output of the digital Tx frontend processing stage.

Example 28 includes the subject matter of Example 27, and optionally, wherein the current data in the digital output of the digital Tx frontend processing stage comprises a current Tx digital signature of a digital radar Tx signal, wherein the reference information comprises a reference Tx digital signature.

Example 29 includes the subject matter of Example 28, and optionally, wherein the processor is configured to generate the FuSa alert based on a determination that the current Tx digital signature and the reference Tx digital signature do not match.

Example 30 includes the subject matter of Example 28 or 29, and optionally, wherein the reference Tx digital signature is based on a predefined Tx digital signature to be applied to a digital input of the digital Tx frontend processing stage.

Example 31 includes the subject matter of Example 30, and optionally, comprising a Tx pattern generator configured to generate the predefined Tx digital signature, and to apply the predefined Tx digital signature to the digital input of the digital Tx frontend processing stage.

Example 32 includes the subject matter of any one of Examples 1-31, and optionally, wherein the processor is configured to monitor a digital output of a digital Rx frontend processing stage of the imaging radar processing path, and to detect the FuSa event based on current data in the digital output of the digital Rx frontend processing stage.

Example 33 includes the subject matter of Example 32, and optionally, wherein the current data in the digital output of the digital Rx frontend processing stage comprises a current Rx digital signature of a digital radar Rx signal, wherein the reference information comprises a reference Rx digital signature.

Example 34 includes the subject matter of Example 33, and optionally, wherein the processor is configured to generate the FuSa alert based on a determination that the current Rx digital signature and the reference Rx digital signature do not match.

Example 35 includes the subject matter of Example 33 or 34, and optionally, wherein the reference Rx digital signature is based on a predefined Rx digital signature to be applied to a digital input of the digital Rx frontend processing stage.

Example 36 includes the subject matter of Example 35, and optionally, comprising an Rx pattern generator configured to generate the predefined Rx digital signature, and to apply the predefined Rx digital signature to the digital input of the digital Rx frontend processing stage.

Example 37 includes the subject matter of any one of Examples 1-36, and optionally, wherein the digital output of the radar processing stage comprises a Tx frontend digital output based on an output of an analog Tx frontend processing stage of the imaging radar processing path, wherein the processor is configured to detect the FuSa event based on current data in the Tx frontend digital output.

Example 38 includes the subject matter of Example 37, and optionally, wherein the current data in the Tx frontend digital output comprises a current Tx power level of a current analog radar Tx signal, wherein the reference information comprises a previous Tx power level of a previous analog radar Tx signal.

Example 39 includes the subject matter of Example 38, and optionally, wherein the processor is configured to generate the FuSa alert based on a determination that a difference between the current Tx power level and the previous Tx power level is greater than a Tx power level threshold.

Example 40 includes the subject matter of any one of Examples 37-39, and optionally, wherein the Tx frontend digital output comprises an output of a Tx Analog to Digital Converter (ADC), the output of the Tx ADC is based on the current analog Tx radar signal.

Example 41 includes the subject matter of any one of Examples 1-40, and optionally, wherein the digital output of the radar processing stage comprises an Rx frontend digital output based on an output of an analog Rx frontend processing stage of the imaging radar processing path, wherein the processor is configured to detect the FuSa event based on current data in the Rx frontend digital output.

Example 42 includes the subject matter of Example 41, and optionally, wherein the Rx frontend digital output comprises a current Rx power level of a current analog radar Rx signal, wherein the reference information comprises a previous Rx power level of a previous analog radar Rx signal.

Example 43 includes the subject matter of Example 42, and optionally, wherein the processor is configured to generate the FuSa alert based on a determination that a difference between the current Rx power level and the previous Rx power level is greater than an Rx power level threshold.

Example 44 includes the subject matter of any one of Examples 41-43, and optionally, wherein the Rx frontend digital output comprises an output of an Rx Analog to Digital Converter (ADC), the output of the Rx ADC is based on the current analog Rx radar signal.

Example 45 includes the subject matter of any one of Examples 1-44, and optionally, wherein the plurality of radar processing stages comprises at least one processing stage of a digital Tx frontend processing stage to generate Tx digital signals, an analog Tx frontend processing stage to transmit the radar Tx signals based on the digital Tx signals, an analog Rx frontend processing stage to process the radar Rx signals, a digital Rx frontend processing stage to generate digital radar Rx signals based on the radar Rx signals, a matched filter processing stage to generate information of a plurality of range bins based on the digital radar Rx signals, a Doppler processing stage to generate a range-Doppler (RD) map based on the information of the plurality of range bins, an Angle of Arrival (AoA) processing stage to generate an AoA map based on the RD map, a processing stage to process the AoA map, or a target detection stage to detect targets based on the AoA map.

Example 46 includes the subject matter of any one of Examples 1-45, and optionally, comprising a radar device, the radar device comprising a plurality of Tx antennas to transmit the radar Tx signals, and a plurality of Rx antennas to receive the radar Rx signals.

Example 47 includes the subject matter of Example 46, and optionally, comprising a vehicle, the vehicle comprising the radar device, and a system controller to control one or more systems of the vehicle based on the radar information.

Example 48 includes a vehicle comprising the apparatus of any of Examples 1-47.

Example 49 includes an apparatus comprising means for performing any of the described operations of any of Examples 1-47.

Example 50 includes a machine-readable medium that stores instructions for execution by a processor to perform any of the described operations of any of Examples 1-47.

Example 51 comprises a product comprising one or more tangible computer-readable non-transitory storage media comprising computer-executable instructions operable to, when executed by at least one processor, enable the at least one processor to cause a device and/or system to perform any of the described operations of any of Examples 1-47.

Example 52 includes an apparatus comprising a memory; and processing circuitry configured to perform any of the described operations of any of Examples 1-47.

Example 53 includes a method including any of the described operations of any of Examples 1-47.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising:
a Functional Safety (FuSa) detector configured to detect FuSa events of an imaging radar processing path comprising a plurality of radar processing stages to generate radar information based on transmission of radar transmit (Tx) signals and processing of radar receive (Rx) signals based on the radar Tx signals, the FuSa detector comprising:
an input to receive a digital output of a radar processing stage of the imaging radar processing path;
a processor configured to monitor the digital output, and to detect a FuSa event based on current data of the digital output and reference information corresponding to the radar processing stage; and
an output to provide a FuSa alert to indicate detection of the FuSa event.

2. The apparatus of claim 1, wherein the reference information corresponding to the radar processing stage represents expected data in the digital output of the radar processing stage when no FuSa event is to be detected.

3. The apparatus of claim 1, wherein the reference information corresponding to the radar processing stage is based on previous data in the digital output.

4. The apparatus of claim 3, wherein the previous data of the digital output comprises a previous value of a predefined parameter in the digital output, wherein the processor is configured to identify a current value of the predefined parameter in the digital output, and to detect the FuSa event based on a comparison between the current value of the predefined parameter and the previous value of the predefined parameter.

5. The apparatus of claim 4, wherein the processor is configured to detect the FuSa event based on a difference between the current value of the predefined parameter and the previous value of the predefined parameter.

6. The apparatus of claim 5, wherein the processor is configured to generate the FuSa alert based on a determination that the difference between the current value of the predefined parameter and the previous value of the predefined parameter is greater than a difference threshold.

7. The apparatus of claim 1, wherein the reference information comprises a reference digital signature.

8. The apparatus of claim 7, wherein the processor is configured to identify a current digital signature in the current data, and to detect the FuSa event based on a comparison between the current digital signature and the reference digital signature.

9. The apparatus of claim 7, wherein the reference digital signature is based on a predefined digital signature to be applied to a digital input of the radar processing stage.

10. The apparatus of claim 9 comprising a pattern generator configured to generate the predefined digital signature and to apply the predefined digital signature to the digital input of the radar processing stage.

11. The apparatus of claim 1, wherein the digital output of the radar processing stage comprises an output of an Analog to Digital Converter (ADC) based on analog radar signals processed by an analog radar processing stage of the imaging radar processing path.

12. The apparatus of claim 1, wherein the processor is configured to monitor a digital output of a Doppler processing stage of the imaging radar processing path, and to detect the FuSa event based on current data in the digital output of the Doppler processing stage.

13. The apparatus of claim 12, wherein the current data in the digital output of the Doppler processing stage comprises a current noise floor level of a Range-Doppler (RD) map, wherein the reference information comprises a previous noise floor level of the RD map.

14. The apparatus of claim 1, wherein the processor is configured to monitor a digital output of a matched filter processing stage of the imaging radar processing path, and to detect the FuSa event based on current data in the digital output of the matched filter processing stage.

15. The apparatus of claim 14, wherein the current data in the digital output of the matched filter processing stage comprises a current leakage level of a first-in-order range-bin, wherein the reference information comprises a previous leakage level of the first-in-order range-bin.

16. The apparatus of claim 1, wherein the processor is configured to monitor a digital output of an Angle of Arrival (AoA) processing stage of the imaging radar processing path, and to detect the FuSa event based on current data in the digital output of the AoA processing stage.

17. The apparatus of claim 16, wherein the current data in the digital output of the AoA processing stage comprises a current side lobe level (SLL) value of an AoA map of a Range-Doppler (RD) bin, wherein the reference information comprises a previous SLL value of the AoA map of the RD bin.

18. The apparatus of claim 1, wherein the processor is configured to monitor a digital output of a digital Tx frontend processing stage of the imaging radar processing path, and to detect the FuSa event based on current data in the digital output of the digital Tx frontend processing stage.

19. The apparatus of claim 18, wherein the current data in the digital output of the digital Tx frontend processing stage comprises a current Tx digital signature of a digital radar Tx signal, wherein the reference information comprises a reference Tx digital signature.

20. The apparatus of claim 1, wherein the processor is configured to monitor a digital output of a digital Rx frontend processing stage of the imaging radar processing path, and to detect the FuSa event based on current data in the digital output of the digital Rx frontend processing stage.

21. The apparatus of claim 20, wherein the current data in the digital output of the digital Rx frontend processing stage comprises a current Rx digital signature of a digital radar Rx signal, wherein the reference information comprises a reference Rx digital signature.

22. The apparatus of claim 1, wherein the digital output of the radar processing stage comprises a Tx frontend digital output based on an output of an analog Tx frontend processing stage of the imaging radar processing path, wherein the processor is configured to detect the FuSa event based on current data in the Tx frontend digital output.

23. The apparatus of claim 22, wherein the current data in the Tx frontend digital output comprises a current Tx power level of a current analog radar Tx signal, wherein the reference information comprises a previous Tx power level of a previous analog radar Tx signal.

24. The apparatus of claim 22, wherein the Tx frontend digital output comprises an output of a Tx Analog to Digital Converter (ADC), the output of the Tx ADC is based on the current analog Tx radar signal.

25. The apparatus of claim 1, wherein the digital output of the radar processing stage comprises an Rx frontend digital output based on an output of an analog Rx frontend processing stage of the imaging radar processing path, wherein the processor is configured to detect the FuSa event based on current data in the Rx frontend digital output.

26. The apparatus of claim 25, wherein the Rx frontend digital output comprises a current Rx power level of a current analog radar Rx signal, wherein the reference information comprises a previous Rx power level of a previous analog radar Rx signal.

27. A radar system comprising:
a plurality of Transmit (Tx) antennas to transmit radar Tx signals;
a plurality of Rx antennas to receive radar Rx signals based on the radar Tx signals;
an imaging radar processing path comprising a plurality of radar processing stages to generate radar information based on transmission of the radar Tx signals and processing of the radar Rx signals; and
a Functional Safety (FuSa) detector configured to detect FuSa events of the imaging radar processing path, wherein the FuSa detector is configured to:
monitor a digital output of a radar processing stage of the imaging radar processing path;
detect a FuSa event based on current data of the digital output and reference information corresponding to the radar processing stage; and
provide a FuSa alert to indicate detection of the FuSa event.

28. The radar system of claim 27, wherein the reference information corresponding to the radar processing stage represents expected data in the digital output of the radar processing stage when no FuSa event is to be detected.
